(19) United States
(12) Patent Application Publication
(10) Pub. No.: US 2021/0256486 A1
(43) Pub. Date: Aug. 19, 2021

(54) Computer Based System and Method for Controlling Third Party Transacting Through a single Interface

(71) Applicant: Peter Garrett, Mill Valley, CA (US)

(72) Inventor: Peter Garrett, Mill Valley, CA (US)

(21) Appl. No.: 17/191,503

(22) Filed: Mar. 3, 2021

Related U.S. Application Data
(63) Continuation-in-part of application No. 17/156,389, filed on Jan. 22, 2021.
(60) Provisional application No. 62/991,835, filed on Mar. 19, 2020.
(60) Provisional application No. 62/977,651, filed on Feb. 17, 2020.

(51) Int. Cl. G06Q 20/02; G06Q 20/40; G06Q 30/02; G06Q 40/08

(52) U.S. Cl. CPC G06Q 20/02; G06Q 40/08; G06Q 30/0226; G06Q 20/401

(57) ABSTRACT

A financial transaction network includes a first and second server platforms connected to the network the first server holding and managing a consumers financial account data and functioning to communicate value offers to the consumers by aggregating data about the consumer and matching that data to data held at the second server functioning as a value offer presentation server including a server interface distributed over the network to consumer computing appliances the server interface functioning as a communications and transaction tunnel between the third party platforms sponsoring value offers and the first server when the consumer is transacting. The value offers culled according to consumer pattern data aggregated by the first server.

### CROSS-REFERENCE TO RELATED DOCUMENTS

The present invention is a continuation in part (CIP) to a U.S. patent application Ser. No. 17/156,389, entitled COMPUTER-BASED SYSTEM AND METHOD FOR TARGETING FINANCIAL GOALS VIA ELECTRONIC CODE OR COUPON AUCTIONS filed on Jan. 22, 2021, which claims priority to a U.S. provisional patent application Ser. No. 62/977,651, filed on Feb. 17, 2020. The instant application also claims priority to provisional patent application Ser. No. 62/991,835 filed on Mar. 19, 2020 entitled “Computer-Based System and Method for Targeting Financial Goals via Electronic Code or Coupon Auctions”. The disclosures all applications mentioned above are included herein at least by reference.

### BACKGROUND OF THE INVENTION

### 1. Field of the Invention

The invention relates generally to computer methods and systems for processing electronic data related to finance, more specifically, to provision of a single interface for transacting with selected ones of third-party platforms or servers.

### 2. Discussion of the State of the Art

In the arts of financial management much evolution has occurred toward enabling a typical consumer to achieve basic goals of consumerism and consumer protection such as reducing the number of steps required to complete transactions, making financial data more readily available to the user, allowing the user easy access to price comparison analysis, improving the user's general experience relative to products and services sought by the consumer, improving fraud detection on behalf of users, and so on.

More recently in the art, users may store financial related data on third party platforms that may perform specific services for users who engage in online consumer practices. Such data may be downloaded by the user and written to dynamic transactional cards or devices for use in transacting. Such third-party platforms, generally referred to herein as money pay services may provide transactional management services to users including management of purchases made, receipts accrued, rewards points accrued, tax deductibles, purchase categorizations, spending analysis, purchase history management, and so on.

Relationships between issuers of consumer accounts and these third-party platforms enable aggregation of financial related data of user's accounts registered with those platforms and make it more convenient for users to make purchases and perform tasks with less effort. However, much improvement is needed to further refine consumer goals such as use of earned points, application of discounts, competition in comparing offers, ease of distributing and accepting payments, and other tasks that currently require a user to access more than one platform, service provider, account issuing entity, and user interface.

Likewise, companies who offer online services and products seek to improve and develop new ways to advertise to consumers, retain consumer loyalty, and improve access to more consumers they may add to their client bases. Providers use memberships, loyalty programs, bonus programs, temporary price reductions, discounts for quantity programs, etc. in efforts to compete against other providers for consumer business.

The inventor is aware of a computer aided financial transaction network that includes a first server connected to the network remote from a consumer's computing appliance wherein the first server manages a data repository containing financial account data belonging to the consumer and a server interface to the first server distributed over the network to the computing appliance of the consumer and at least one or more second server connected to the network, the one or more second servers coupled to at least one data repository containing data supporting one or more types of third party auctions.

Executable machine-readable code provided on a non-transitory medium resident on or coupled to the first server instructs the first server to register financial account data for the consumer in a consumer account registry stored by the first server. Solicit from the consumer over the network, financial goals in the form of savings goals and or spending goals of the consumer relative transaction activity by the consumer and associate those goals to individual ones of the consumer's financial accounts, creating one or more rules-based executable routines or commands and associating them to individual ones of the consumer accounts and goals of (b), (d) upon invocation by individual ones of the consumers of the server interface to the first server, sending a bid request to the one or more second servers requesting least one electronic auction event, the request including information defining the one or more financial goals of the consumers solicited in (b) to the second server, the auction event held among product and or service providers notified of the event by the one or more second severs, and (e) upon selection by the consumer of a winning offer associated with one or more products or services offered by the providers, performing one or more calculations to achieve or to advance one or more of the consumer's financial goals including performing a transaction.

It is desired in the art of online transacting to maintain online security while transacting and to limit the number of required network hops or redirects between servers when navigating third party links that may offer products or services of interest to the consumer. It is also desired that meta data about products and services be available to a consumer to make purchasing decisions. It is further desired that information or competitive data about the same or similar products or services of interest to the consumer be available to the consumer.

However, in current art transacting environments, application program interfaces (APIs) and multiple link navigation sequences may be required to connect a consumer end node to a secure transaction server for conducting a transaction. Moreover, seeking more information about the same or other comparable products or services may require additional navigation (multiple hops).

Therefore, what is clearly needed is a computer-based method for enabling selective transacting with third party providers through a single interface.

### BRIEF SUMMARY OF THE INVENTION

According to an embodiment of the present invention, a financial transaction network includes a first server connected to the network, the first server coupled to at least one data repository containing financial account data belonging to individual ones of consumers identified by a unique code, a second server connected to the network, the second server coupled to at least one data repository containing data supporting third-party value offers in the form of products and services, a server interface to the first server distributed over the network to individual ones of computing appliances connected to the network as end nodes, the computing appliances operated by the consumers, and a non-transitory medium resident on the first server, the non-transitory medium containing machine-readable code thereon, the code executable and instructing the first server to (a) register financial account data for the individual ones of consumers in a consumer account registry on the first server and create a unique token for each registered consumer for authentication at the first server, (b) oversee consumer selection or creation one or more rules-based executable routines or commands and association of created rules to individual ones of consumer accounts, (c) aggregate pattern data about the registered consumers and storing or caching that data for use as search criteria for locating value offers, (d) host the execution of the server interface and upon execution thereof spawning an interactive meta browser window to display on the consumer's computing appliances,(e) use some of or all of the consumer pattern data aggregated in (c) as criteria to match with third party value offers, and (f) communicate one or more of the matched value offers to the consumer through the server interface.

In one embodiment, the unique code includes a user account registry code and a personal verification code. In one embodiment, the financial account data may include a proxy financial account number associated with an actual financial account number residing on a third-party server. In one embodiment, in (a) the unique token comprises the domain of consumer's end node or the domain of software component residing on the consumer's end node.

In one embodiment, in (b) the one or more rules-based executable routines or commands are automatically triggered by one or more actions by the consumer, the one or more actions identified in the one or more rules. In one embodiment, in (c) the aggregated pattern data about the registered consumers is aggregated locally and uploaded to the first server by the consumer end node. In the same or another embodiment, in (c) the aggregated pattern data about the registered consumers is aggregated at the first server.

In a preferred embodiment, in (d) the server interface is nested in one or more of the consumer's preferred resident browser applications. In one embodiment, in (d) the interactive meta browser window is executed manually by the consumer. In one embodiment, in (d) the meta browser window uses specific input capabilities to enable consumer hover-over of interactive content to execute display of hidden meta data associated with the content. In one embodiment, in (e) the criteria to match with value offers is configurable by the consumer to be narrowed or to be broadened.

In a preferred embodiment, in (f) the matched value offers are communicated as compartmental interactive advertisements including interactive graphics, interactive text, and at least one universal resource locator (URL) to a secure transaction Web page. Also, in a preferred embodiment, in (e) the value offers may be provided by or sponsored by online merchants including reward incentives providers, banks, internet payment providers, barter providers, insurance companies, credit account organizations, and brokerage firms.

In one embodiment, in (a) the unique code further includes a software cookie, a telephone number, an email address, a subscriber identification card number, an internet protocol address, a customer computing token hardware identification number, or a data string generated by the remotely located server. In one embodiment, the visible advertisement data or associated meta data includes one or a combination of product pricing data, product dimension data, product color data, product or service operation data, product or service feature description, product or service title or brand identification data, name of manufacturer or provider, product delivery or pick-up availability data or service start data, and location data for product pickup.

In one embodiment, in (d) the server interface spawns one or more additional interactive pop-up windows communicating compartmental interactive advertisements representing the value offers matched to using consumer pattern data for products or services. In one embodiment, in (d) transactions may be initiated by the consumer selecting a preferred account displayed within the pop up meta browser window. In another embodiment, in (d) transactions may be initiated by the first database by proxy for the consumer, the first database functioning as an agent representing the consumer. In one embodiment, in (e) the criteria to match with value offers is specifically limited to data about accessories a consumer may add to a product the consumer has purchased, is in the process of purchasing, or will purchase. In one embodiment, in (c) the aggregated data is periodically retrieved from the consumer's appliance through the server interface on a periodic basis.

### BRIEF DESCRIPTION OF THE SEVERAL VIEWS OF THE DRAWINGS

FIG. 1 is a flow chart depicting steps for registering financial-related data through auction until a targeted financial goal(s) is/are met.

FIG. 2 is a block diagram depicting configurations of the first database, some optional components thereof, including financial account rules and auction rule associations.

FIG. 3A is a block diagram depicting a data platform adapted for working with financial relative data including user registration data and financial account management.

FIG. 3B is a block diagram depicting the first database of FIG. 2 and several components thereof and interactions with third-party platforms.

FIG. 4 depicts a line graph plotting a representative growth rate of a user's financial wealth over a period of time toward a user-set financial goal.

FIG. 5 is a block diagram depicting a distributed architecture 500 networks connecting redundant first databases, subset databases, third-party platforms, and user computers.

FIG. 6A is a screen shot depicting a third-party Web page presenting access to a browser extension invoked to access the first database according to an embodiment of the invention.

FIG. 6 B is a screen shot of the third-party Web page of FIG. 6A depicting secure transfer of data from the first database to the end device browser.

FIG. 6C is a screen shot of the third-party Web page of FIG. 6A depicting secure transfer of data from the end device browser to the first database.

FIG. 7 is an architectural diagram, depicting the auto-population of financial accounts into the first database of FIG. 2 authorized by credit approval.

FIG. 8 is a block diagram depicting general processing, analytical components, and process categories in the first database SW.

FIG. 9 is a block diagram depicting processing on a neural subsection platform.

FIG. 10 is a process flow chart depicting steps for training the AI model of FIG. 9.

FIG. 11 is a block diagram depicting intelligent processing of instant transactions using the AI model of FIG. 9.

FIG. 12 is an architectural view of the network interaction between a consumer and competing third party platforms.

FIG. 13A is a screen shot of a consumer appliance display depicting a visited third-party Web page and a meta browser pop up window customized to a consumer according to an embodiment of the invention.

FIG. 13B is a screen shot the consumer appliance display of FIG. 13A including the third-party Web page of FIG. 13A being auto populated with pattern data from the meta browser pop up window.

FIG. 13C is a screen shot of the consumer appliance display depicting a product selected by the consumer picked up by the interactive browser pop up window for use in locating similar products.

FIG. 13D is a screen shot of the consumer's appliance display of FIG. 13A including a second interactive pop-up window executed by the meta browser for display of results of a comparison data search.

FIG. 14 is a process flow chart depicting steps for enabling and invoking the intelligent SW agent of FIG. 13D according to one aspect of the invention.

### DETAILED DESCRIPTION OF THE INVENTION

In various embodiments described in enabling detail herein, the inventor provides a unique system and method for transacting over a network with selected ones of more than one third party platform. The present invention is described using the following examples, which may describe more than one relevant embodiment falling within the scope of the invention.

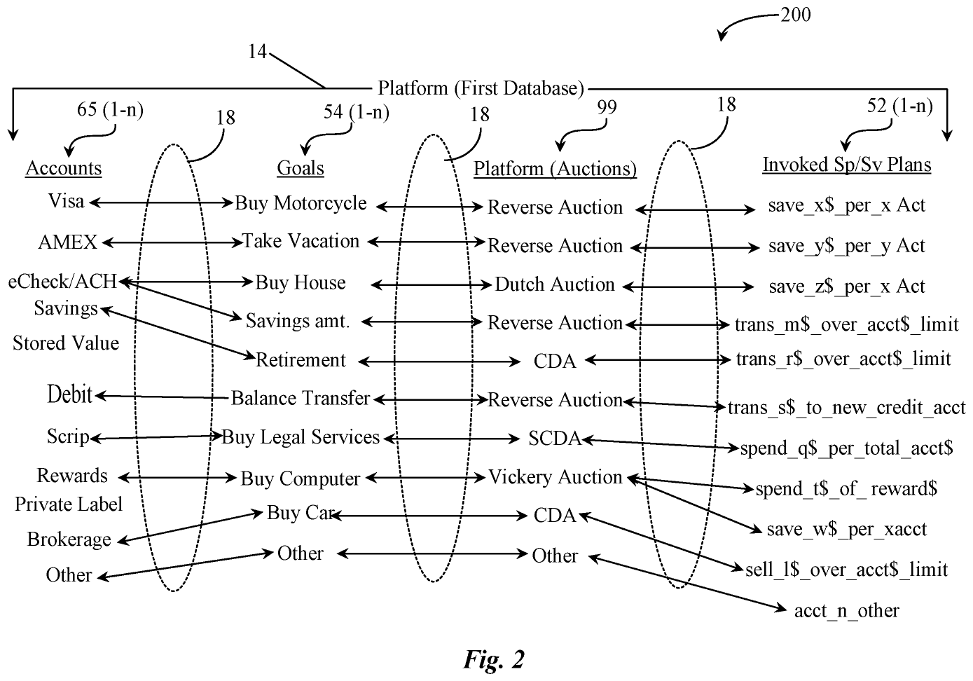

Referring now to FIG. 2, a block diagram 200 depicts exemplary configurations of a platform 14 also referred to herein as a first database 14 hosted on a network 18 and accessible to a consumer from a personal computing appliance connected to the network. Platform 14 may be accessible to a consumer having a personal computing appliance able to connect to and browse the network 18 employing a browser and a browser extension or meta-browser the consumer may invoke when visiting a provider web site. Platform 14 is a distributed database in one implementation of the present invention that may include mirror servers, proxy servers and data storage facilities that may be separated by the network 18.

Network 18 may be a wide-area-network (WAN) like the Internet that includes sub-networks connected thereto including wireless and wired data networks accessible to a consumer computing appliance, for example, an Ethernet LAN or a wireless communications carrier network. Network 18 logically represents all of the above network types including financial network channels using secure transaction settings.

First platform 14 may include the domain of a cloud-based payment service sub platform where a consumer may register financial accounts 65(1-n) and receive account services relative to transacting online or offline. Financial accounts 65(1-n) may include Visa, AMEX, eCheck/ACH, Savings, Stored Value, Debit, Scrip, Rewards, Private Label, Brokerage, and other account types (n). Consumer accounts 65 are accessible to the consumer operating a computing appliance, in one implementation, through a Web site and a meta browser extension, or in another implementation, through a thin client SW application running on a wireless device like a cellular phone. In one implementation, platform 14 may be an account issuer of some or all of financial account 65(1-n) of a consumer, wherein the platform may operate as a financial institution like a bank or credit issuer and or a rewards provider for the consumer.

Platform 14 includes a sub platform 99 for holding auctions, sub platform 99 is separated by network 18 from the consumer account sub platform hosting registered consumer accounts 65(1-n). Sub platform 99 may hereinafter be referred to as auction platform 99. Auction platform 99 may be adapted to service business-to-business (B2B), business-to-consumer (B2C), and consumer-to-consumer (C2C) bidding activity and secure transaction activity. Auction platform 99 may be a Third Party (TP) platform that may be considered a different platform from platform 14 without departing from the spirit and scope of the present invention.

Platform 14 includes memory storage facilities such as data repositories implemented in memory and controlled by one or more servers. Such repositories may hold data generally defined as pattern data 54(1-n) representing, in this implementation, goals a consumer practicing the present invention may desire to achieve over a short period or longer period dependent at least in part by the particular type of goal and if the goal is to be repeated. Goals may be associated to one or more than one financial account 65(1-n).

Goals 54 may be any designated goal of the user typically in the form of any product and or any service. General examples of a targeted financial goal may include buying a car, raising a down payment for a house, taking a vacation, setting a retirement fund dollar amount, donating an amount to a non-profit charity, reducing credit card debt, reducing credit card interest rates by transferring balances to new credit cards, purchasing legal services, buying a computer, buying inventory or supplies for a factory or office, buying a concert ticket or gym membership, saving on a layaway plan for purchasing a motorcycle, and or buying insurance for life, disability, or long-term care.

Goals 55(1-n) may be dynamic and may be implied or suggested in some implementations of the present invention by system monitors such as monitors of online activity, search activity, messaging activity, and SM preferences and activities. Goals 55(1-n) may also be input into platform 14 by a consumer directly. In still another implementation, goals 54(1-n) may be predicted based on data mining and analysis of aggregated activity data including browsing data patterns, search data patterns, and social media patterns.

In this embodiment, goals 54(1-n) are all associated with individual ones of consumer accounts 65(1-n), for example, a consumer goal 54(1) (buy motorcycle) is a targeted goal associated with a consumer-registered visa account 65(1). Further to the above, a target goal 54(2) (take a vacation) has direct association to consumer account 65(2), which is an (AMEX) account. Other consumer driven goals listed include 54(3) (buy house), associated with a consumer registered account 65(3) (eCheck/ACH). Other goals set include Saving of an amount of money, retirement (may be date dependent), balance transfer, buy legal services, buy a computing appliance, buy a motor vehicle, these goals associated to the various accounts under accounts 54(I-n), which are listed further above.

Platform 14 may include execution commands 52(1-n) provided for executing transactional routines related to savings and to spending plans. It is assumed in this embodiment that parties including consumers and providers that wish to either originate or receive financial transactions are registered to access platform 14 through an associated verification program and be recorded and profiled in a user account registry. The exact verification requirements and financial information registered with platform 14 for a given user depends somewhat upon the mode desired to originate or receive settlement.

A user, which may be an individual consumer or a corporate entity, may register at least one unique user code (UUC) (not illustrated here, and optionally a personal verification code (PVC), also not illustrated here. Data such as a plurality of Financial Accounts 65(1-n) may be associated with at least one Execution Command 52(1-n) that may execute routines adapted to access, deposit, display, deduct, and disburse financial data belonging to at least one financial account 65(1-n).

A consumer's financial goal may be detailed and associated to one or more accounts (65(1-n) and an invitation to bid (IFB) notification may be transmitted over the network 18 by the consumer (or other user profile) or on behalf of the consumer (or another user profile) to auction platform 99 to a specific auction type, if desired and available. An IFB invitation may invoke or trigger TP providers of goods and services that most pertain to an associated consumer goal or goals 54(1-n). For example, if a consumer has an image or a textual or audio description of a specific motorcycle they desire to buy (goal 54(1)), the IFB generated may include specific details like make, model, year, cost or budget, payment terms, a time deadline, and other relevant factors and minimum qualifications that could influence and inform prospective TP providers of motorcycles who may want to bid in an electronic auction to determine who will have first access to the consumer.

An IFB Invoked and transmitted directly to the auction platform may function to reduce the time required for the auction platform 99 to invoke a bidding process and complete an electronic auction. A consumer may refine the decision process by choosing the most qualified bidder with the lowest-priced bid. Bidders may focus more narrowly on estimating the potential costs associated with providing the product or service which most closely pertains to the goal or goals of the consumer and may, with more expedience, produce a bid. In one implementation, a consumer's target financial goal is just an overview, or is somewhat general relative to rich description or specific consumer requirements. In such a case, a request for proposal (RFP) may be transmitted by a consumer or on behalf of the consumer to auction platform 99.

Auction platform 99 may host a variety of electronic auction genres including but not limited to reverse auctions, continuous double auction (CDA), or a synthetic continuous double auction (SCDA), and Vickery auctions. Third Parties are registered users who compete for the business of the consumer.

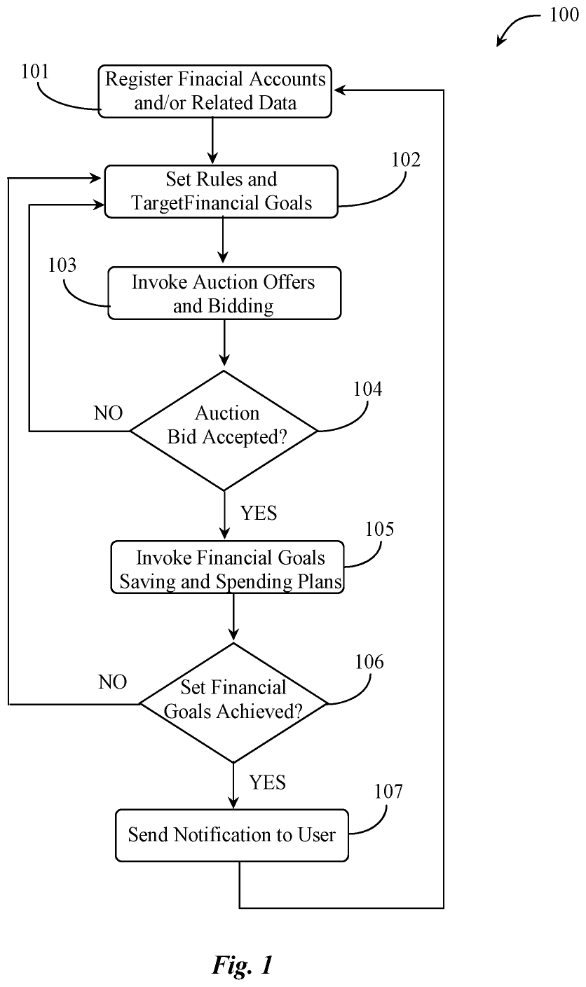

Referring now to FIG. 1, a flow chart 100 depicts steps for consumer registration of financial data and through holding auctions, realizing targeted financial or value goals of the consumer. At step 101, a consumer may register one or more financial accounts or financially relative data with the first database or as it is called platform 14. A verification program secures the data to the consumer. A consumer may be an individual person or a corporate entity. The consumer may create or may be issued at least one unique user code (UUC) and optionally a personal verification code (PVC).

At step 102, the consumer may set rules for financial accounts along with financial goals relative to those registered accounts and associate executable commands relative to those accounts and targeted goals. A targeted goal may be created by a user or in one embodiment may be inferred based on history data or patterns of the consumer.

At step 103, the consumer may invoke auction offers and bidding. There may be differing types of auctions held like a forward or ascending auction, a reverse auction, a Dutch or descending auction, a Vickrey or uniform second price auction, a continuous double auction (CDA), or a synthetic continuous double auction (SCDA). In one embodiment the consumer may view data and or implements and execution commands related to any financial accounts by interacting with a pop-up window invoked by a Web browser extension or a Web meta-browser extension of the first database of platform 14 without requiring application programming interface integration with any web site, and without requiring a form re-direct away from any website.

At step 104 it is determined if a bid has been accepted. If an auction bid has not or will not be accepted by the consumer, then the process may resolve back to step 102 and the consumer may, if desired, modify goals and or rules. Auction types may be offered to the consumer for approval. Third Party providers participate in the auctions to win transaction right to the consumer for provision of the products or services offered to that consumer.

In one embodiment, the platform 14 includes a processing capability to aggregate and process data relative to the consumer, the analysis occurring on platform 14. This sub process may include steps (a) accessing a plurality of Web browsing data and or financial data of the user, (b) quantifying and interpreting the data to reveal data patterns that may be used as metrics, and (c) presenting such refined analysis of the discovered patterns to the consumer on the consumer's personal computing device 62.

If at step 104 a bid is accepted by the consumer, the consumer, or an agent of the consumer (SW) may invoke an execution command at step 105 the execution command (52 1-(n) FIG. 2) operable to calculate and invoke an automated financial plan for saving and or for spending. Thus, enabling the consumer to achieve the targeted financial goal set. Sub processing in this step may include but should not be limited to (a) electronically transmitting the targeted financial goal amount over the network to a third-party platform or database of a provider of services and or products subject to the bidding and relative to the goal, (b) presenting offered services and or products which relate to the consumer's targeted financial goal to the consumer through a user interface (UI), which may be a meta browser, or a client application, (c) invoking an electronic auction via the first database for enabling the user to select at least one of the offered products and or services, (d) completing the electronic auction defined as selection by the consumer of at least one of the offered products and or services subject in the auction, (e) determining the correct automated financial plan for savings or spending, and (f) invoking the automated financial plan of the consumer.

If at step 106, the system may determine if the stated financial goal relative to a spending plan or savings plan associated with one or more registered accounts of the consumer has been achieved. If at step 106, the system determines the ultimate goal was not achieved, the process may loop back to step 102. If at step 106, it is determined that the consumer's target goal has been achieved, then at step 107 the platform may send notification of the completed or otherwise satisfied goal to the user over the network and optionally to the winning product/service provider.

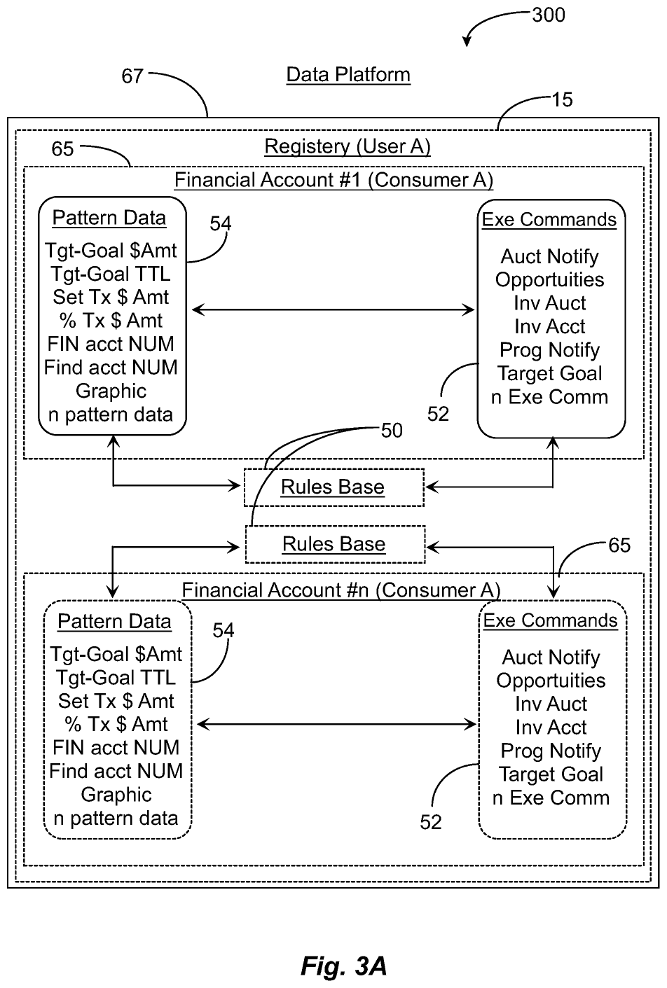

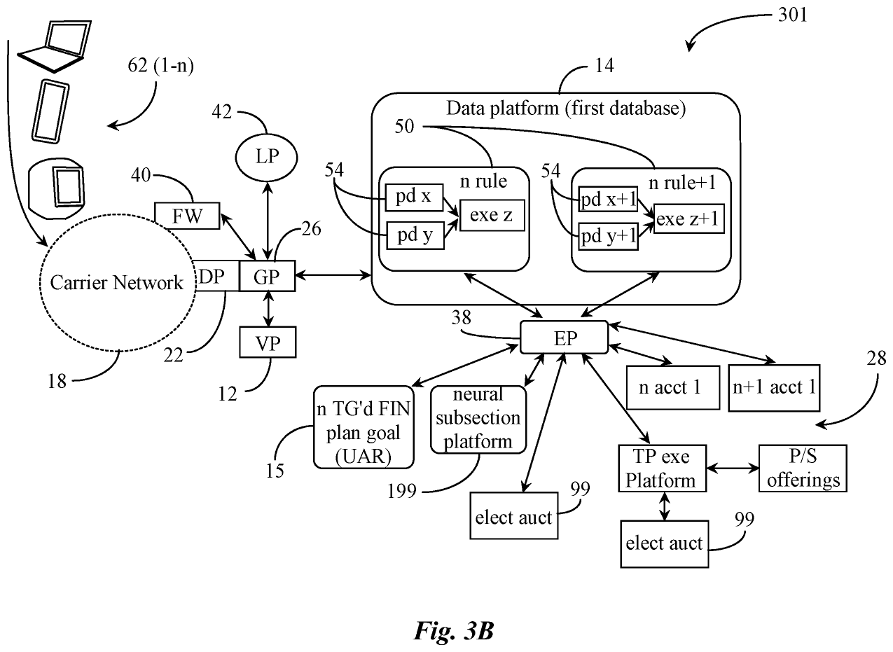

Referring now to FIG. 3A, a block diagram 300 depicts a data platform adapted for working with financial data, user registration data, and providing financial account management. A data platform 67 may be considered a sub-platform limited to the consumer's financially relative data registered in a database on platform 14. Data platform 67 includes predetermined monetary unit value which is legal tender or a legal tender-equivalent such that a consumer's purchase, expenditure, or usage of these units results in the consumer's purchase or sale of goods or services. Financially relative data may be equated to value and may be expressed in terms of units of currency, minutes of telephone calling time, miles towards earning a free airplane flight, points towards a free gallon of gas, and other equivalencies that may be accumulated toward a targeted goal.

Consumer account registry 15 resides on the data platform 67 and includes all of the registered accounts of the consumer. Within financial accounts 65 of a consumer A, for example, pattern data 54 and execution commands 52 are dependent on a rules base 50. Pattern data 54 may be referred to as actions and target goals associated with a specific account. Different consumer accounts may have different sets of pattern data. Here pattern data 54 for a financial account number 1 includes targeted goal dollar amount, target goal time deadline (TTL), set transaction dollar amount, percentage of transaction dollar amount, financial account number, blind account number, a graphic like a picture, emotive, drawing, or logo, and other n pattern data.

Execution commands 52 are associated to the consumer account and set targeted goals associated to the account and may include but are not limited to notification of the consumer of auction opportunities, invocation command to invoke an option to hold an auction, invocation of set savings or spending amounts, progress notifications relative to goal achievement, and other executable n. In this example, consumer account 65(n) is depicted and holds the same basic examples of pattern data 54 and executable commands 52. Rules base 50 may hold the general rules identified for each registered account.

The consumer may authorize a financial transaction using individual ones of accounts 65 either at a merchant point of sale (POS) terminal or over the Internet. Providers may bid in auction to transact with the consumer or provide the consumer with repetitive membership services. In a preferred embodiment, the consumer may override a winning bid and accept a lower bid without departing from the spirit and scope of the present invention.

Referring now to FIG. 3B, architecture 301 depicts an overview of functionality and connection between components of the system of the invention. A consumer makes connection to the system from any computing device or appliance 62(1-n) having network access capability through a carrier network of network 18 and typically an Internet Service Provider (ISP). Data platform 14 includes an electronic verification platform 12 to verify consumers and or third-party platforms attempting to access the platform. A fire wall (FW) 40 may be provided to filter out or reject messages that are not from a verified consumer using a personal computing appliance 62 (1-n).

A decryption platform 22 (DP) may be provided to decrypt consumer messages and data for security purposes in validating the origin computing device or appliance used. In a preferred embodiment, all messages the data platform 14 receives with the exception of those not transmitted via a UIA 16 comprise a UIA-VC 204 sequence number and a message authentication code (MAC). MACs, also known as cryptographic check sums, are well known in the computer industry, and are used to assure that any changes to the content of the message will be detectable by the entity receiving the financial transaction.

The decryption platform (DP) 22 validates the message's MAC and checks the sequence number for that particular UIA 16. If the Decryption Platform 22 determines that both the MAC and the sequence number are valid, the DP 22 uses the unique secret key for that particular UIA 16 to decrypt the message. For the decryption to function properly, the decryption platform 22 must comprise a copy of each UIA's 16 DUKPT key table. In a preferred embodiment, the incoming messages to data platform 14 are decrypted by the decryption platform (DP) 22. Once decrypted, the verification of parties to the transaction is preferably determined using the electronic verification platform (VP) 12.

In one implementation, the data platform 14 including the first database may be conjoined, co-located and or integrated with VP 12 and the user account registry (UAR 15) in any combination thereof. Elements of data platforml4 may be conjoined, co-located and or integrated with a user computing appliance and with a third-party platform 28. In one implementation, a logging platform (LP facility) 42 is adapted to log all electronic financial transaction attempts whether successful or not to write-once media (memory) so that a record is kept of each financial transaction and each error that has occurred during the operation of the verification platform 12. A gateway platform (GP) 26 is provided at the input head of data platform 14 as a database coordinator and message processor.

GP 26 serves as an intermediary between redundant VP 12 and redundant in-house registry 15 (see FIG. 3A) and is charged with routing electronic financial transactions and or electronic transmissions from platforms on overload to platforms that have available capacity (distribution). GP 26 also periodically queries platforms to ensure that are operative and to alert data platform 14 or authorized TP platform 28 administrators if a server is inoperative. In a preferred embodiment, the FW 40 may be a local Internet or sub-Internet router that only handles electronic messages destined for the GP 26 nodes.

On the first database, rules base 50 is depicted as rules 50 governing handling of pattern data 54 and execution commands 52. For example, n rule 50 governs handling of PD X and PD Y using EXE Z. N+1 rule 50 governs handling of PD x+1 and PD Y+1 using EXE Z+1 and so on. UUC and optionally PVC documentation may apply to each electronic process on consumer data or TP data.

An Execution Command 52 is preferably invoked by Pattern Data 54 with which it is associated. Execution Commands 52 are executed by an execution platform (EP) 38. EP 38 enables automated transmission of electronic messages necessary for depositing, displaying, deducting, and or disbursing financial data associated with consumer accounts (65 1−n) and optionally, TP platform 28, such as an issuing bank. Consumer accounts 65 may be arranged within the consumer's user account registry (UAR) 15. UAR 15 may be identified by a user account registry code (UAR-Code) at the “shopping cart” level of a secure transaction site or at a POS terminal. In a preferred limitation, the UAR-Code does not identify a specific consumer account 65 or a specific financial account number belonging to the consumer. It also does not depend upon a specific financial account that might be tagged as a primary account.

In general process, execution command 52 associated with a rule 50 causes an electronic financial transaction to be executed by the execution platform 38. The Execution Platform 38 may be on a platform which is located within the data platform 14 (master first database) or it may be co-located with a TP platform like TP 28 that is external to data platform 14. In the event that a designated TP platform 28 cannot be contacted for the electronic financial transaction to be completed, the financial transaction is “declined”.

In one embodiment, if an account issuer approves a transaction, the EP 38 returns a transaction number to the consumer's UAR 15, and the consumer's financial account 65 is adjusted through either a credit or debit action. The transaction number is returned to the UTA 16, which lists the transaction on a daily transaction summary report. The consumer need take no further action since financial transactions are automatically settled, at which point a calculation is made to automatically adjust the consumer's designated account 65.

In one implementation, a neural network platform 199 or a predictive data modeling platform may be provided as an optional system that may mine aggregated data to produce relevant patterns and relationships between the consumer and entities across multiple variables. Although it is a preferred embodiment, neural platform 199 is not required in order to practice the basic methods of the present invention. Attributes of platform 199 are described further below.

In one implementation, VP 12 platform is physically separate from, but associated and registered with, the data platform 14 (master first database). In one embodiment, UAR 15 platforms may be conjoined with VP 12 within platform 14.

Alternatively, to the above state, they may be housed in independent platforms or joint platforms. In another embodiment, data platform 14 is separately located from UAR 15. UAR 15 is conjoined with a TP 28 and associated and registered with data platform 14. In another embodiment, VP 12 is physically integrated with data platform 14 and the UAR 15, whereby VP 12, data platform 14 and UAR 15 are physically interconnected and integrated together within one server or server platform. In these embodiments, communications among them may occur via many different methods using varying protocols well known in the art. The exact architectures depend partly on the particular communication networks already deployed by an organization or company that deploys an electronic financial transaction authorization system.

In one embodiment, VP 12, data platform 14 and UAR 15 are connected by Ethernet network 18 to a Local router in turn connected to a network operations center (NOC) via frame relay lines. Messages are sent among the VP 12, data platform 14 and the UAR 15 using TCP/IP over network 18. In another embodiment, network 18 may be a cellular digital packet data (CDPD) modem network maintained by CDPD provider that may provide TCP/IP connectivity from the VP 12 to an Intranet 18 to which at least one data platform 14 is connected.

It may be noted herein that the VP 12, data platform 14 (master first database) and the UAR 15 hardware platforms are highly reliant platforms well known in the art such as those available from Sun™, Compag™, Tandem™, and IBM™. Furthermore software (SW) running on VP 12, database 14, and registry 15 may incorporate scalable platform architecture known in the art such as those available from Oracle™, Sybase™ Informix™, Red Hat™ or the like SW packages.

Also, in one embodiment, an execution command optionally requires the data platform 14 and EP 38, to communicate with at least one external third party computer or platform 28 to conduct a consumer's financial transaction. For example, EP 38 may need to communicate with a banking or credit card entity, a merchant's purchasing incentives platform, a financial computer of another party to determine the correct “other” financial party account for financial disbursal. A local or subset database, image of database 14 may be created within a remote TP platform like platform 28.

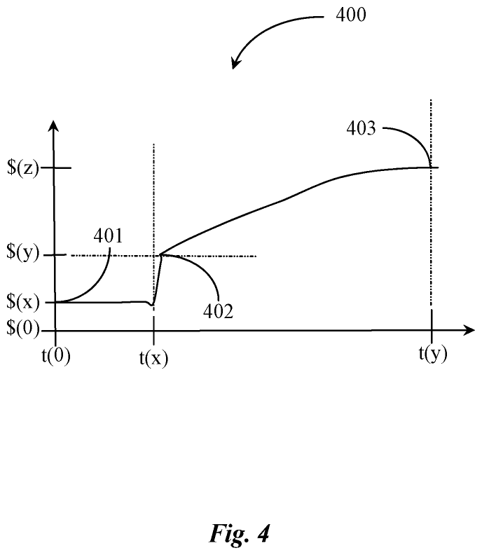

Referring now to FIG. 4, a line graph 400 is depicted, the graph plotting a representative growth rate of a user's financial achievement of a set financial goal over a period of time toward a goal target level. Graph 400 is a two-dimensional line graph having a horizontal x axis representing time (t) and a horizontal y axis representing value in dollars ($).

Intersect 401 (t(0),$(x)) represents the point in time that a consumer registers an account with the system and establishes rules for the account. Intersection 402 (t(x),$(y)) represents a point in time when an auction between provider entities is completed and a provider's products or service has outbid the other provider entities and is accepted by the consumer. Intersection 403 (t(y), $(z)) represents progress made over time t to achieve the goal set by the consumer for that account.

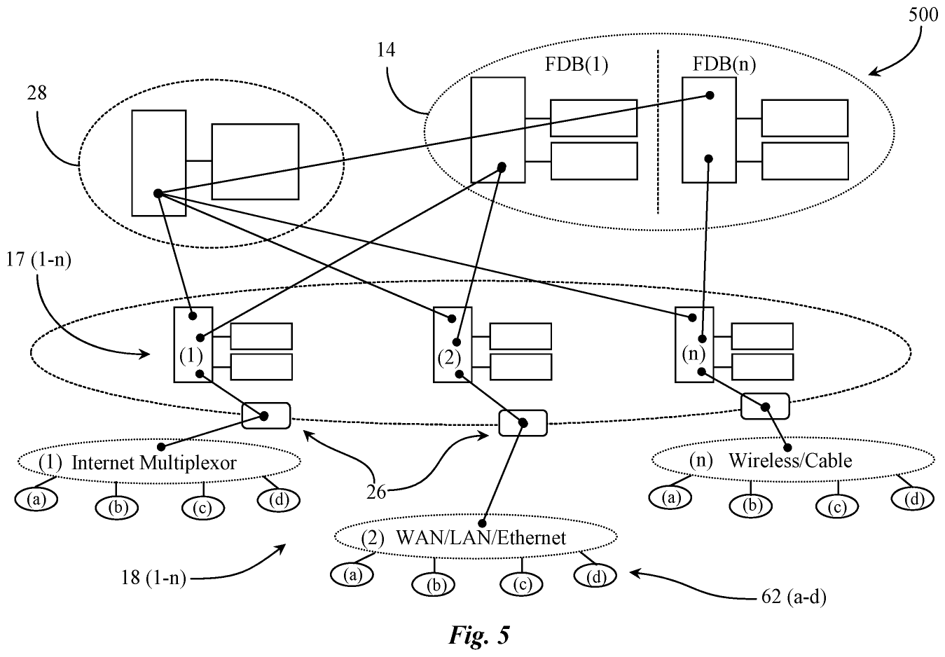

Referring now to FIG. 5, a distributed system architecture 500 is depicted for processing financial transactions by way of subset data platforms 17 under the master data platform 14, the subset databases being distributed remotely over the Internet 18. Architecture 500 supports payment processors at TP platforms 28 to control returning authorization messages to a merchant accessing the TP platforms 28 through gateways to payment networks like Visa™, MasterCard™, Discover™, Interlink™ and American Express™) and or the TP platforms 28 defined as consumer account issuing institutions.

Distribution in this embodiment includes hardware and SW and processing capability. Distributed processing allows for a reduction in latency in transacting over the network making it possible for goals to be realized in some respects in real time while a consumer is making a purchase or otherwise conduction a transaction for goods, services, or for value retention.

In one embodiment, as depicted in FIG. 3B, an execution command 52 optionally requires the first data platform including the master first database 14 and the EP 38 to communicate with at least one external or TP computer or platform 28 to conduct a consumer's financial transaction. EP 38 may need to communicate with a TP entity like banking or credit card entity. Referring now back to FIG. 5, consumer appliances 62(1-d) may access subset data platforms 17(1-n) through networks 18(1-n) (local access/carrier) via gateway platforms (GP) 26(1-n). In one aspect access may be achieved via an Internet multiplexor network 18(1), or a LAN/WAN network 18(2), or through a wireless carrier network or cable network 18(n).

It is duly noted herein that communications between the data platform 14, subset platforms 17, consumer appliances 62-, and third-party platforms 28 may be accomplished through any suitable network 18 like a telephone network, intranet network, Internet network, etc. Consumer points of interaction may include POS terminals, network connected appliances (62) or devices including, personal digital assistant (PDA), cellular or smart phone, kiosk, smart watch, or another smart wearable. Interaction may include online embodiments, offline embodiments, wireless embodiments, etc.

One skilled in the art will appreciate that any databases, platforms, or domains of the present invention may consist of any or a combination of databases, and other mentioned components located singularly with respect to location or distributed (preferred embodiment) at a plurality of locations. Suitable transaction security may include any of various suitable security features and protocols, such as firewalls, access codes, tokens, encryption, decryption, compression, decompression, etc.

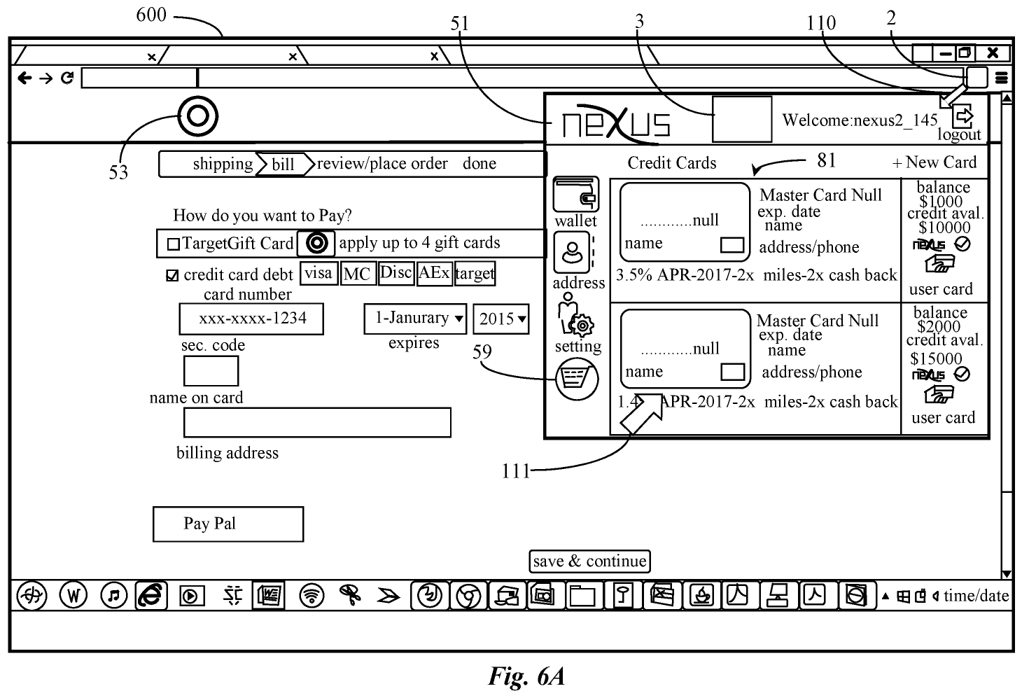

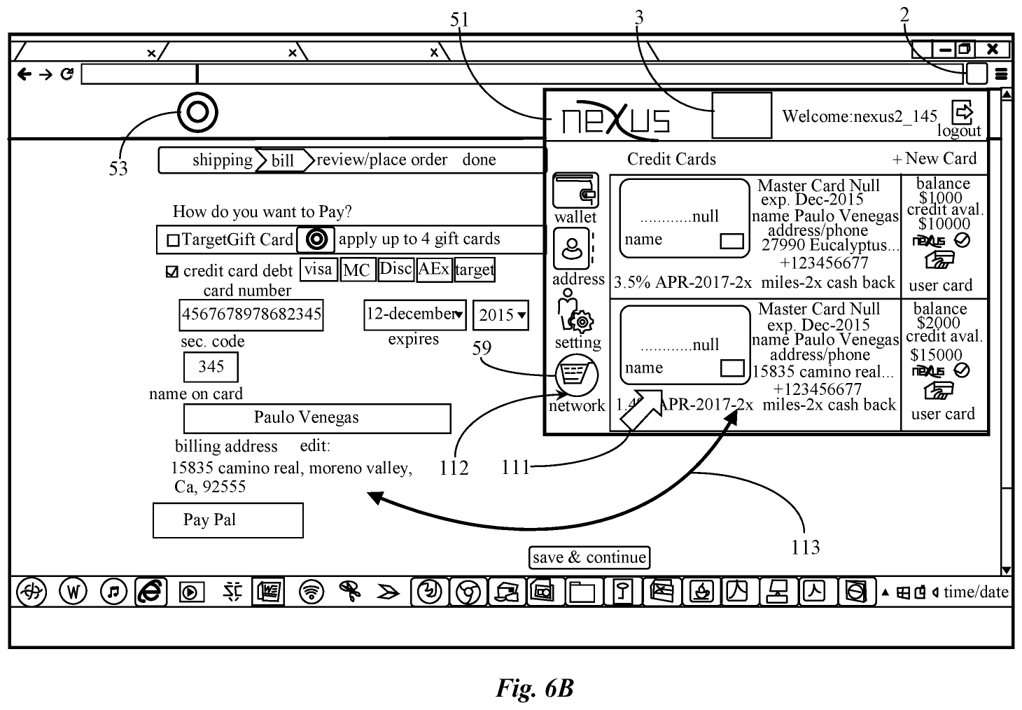

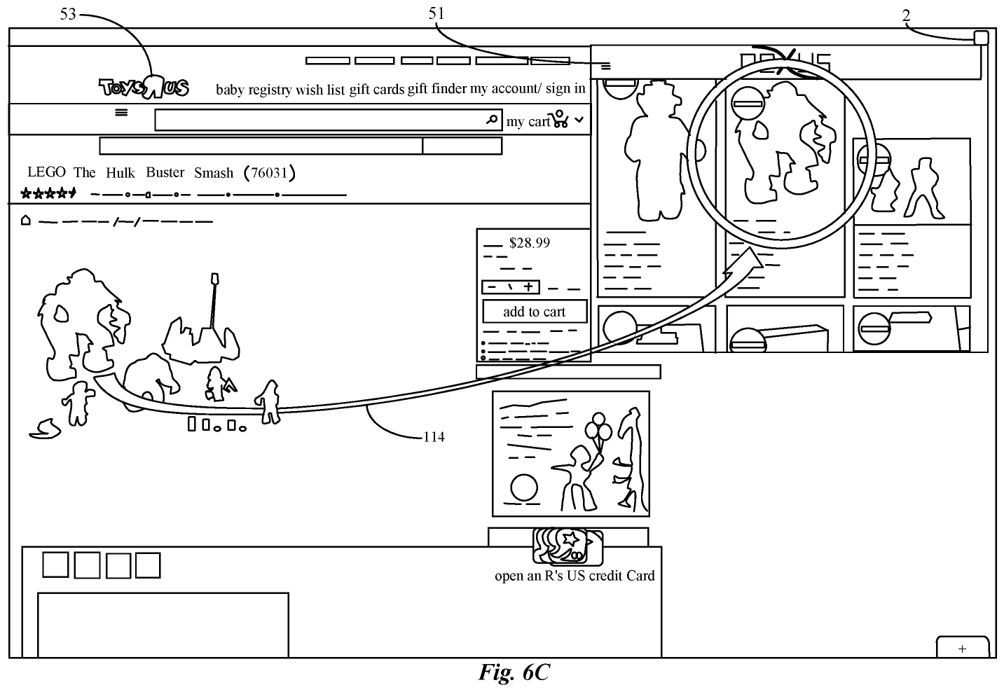

Referring now to FIG. 6A, a screen shot depicting a third-party Web site 53 (Target) includes access to a browser extension 2 invoked to access the first database or first data platform (14) or a subset thereof via a meta browser interactive pop-up window 51. Extension 2 is invoked, which invokes an act 110 that brings up for display the meta browser window 51 displaying a menu of a plurality of visible account signatures 81 in the form of an icon or text representing a consumer financial account 65 registered in the first data platform 14 for presentation to the consumer in the displayed window 51. The consumer may select one of the displayed account signatures to designate that account from accounts 65 for invocation by the first data platform 14 as the account that would be used to complete the transaction.

The menu (window 51) may include current interest rates, available credit lines, expiration dates, and current balances. Window 51 may also include an advertisement 3 personalized to the consumer based on data mining and analysis of the consumer's data (67) resulting perhaps from tracking the consumer's browsing and purchase patterns across a plurality of the consumer's browser-based appliances (62). Other consumer profiling methods may also be used in combination with or separate from tracking browsing activity. Rule modules or simply rules (50) are adapted among other things to invoke preferences, tagging, and rankings 111 of consumer accounts including designated default consumer accounts and a private code, which the user may select at registration and which may be presented by the first data platform to the consumer on the consumer's personal appliance to confirm that the user is accessing the authentic database 14 and any authentic third party platform registered with or recognized by the first data platform.

In a preferred embodiment, the predetermined criteria for ranking 111 may include improving a transaction benefit for a payee like a merchant, or for the consumer. Ranking 111 may be equivalent to improving a transaction benefit to increase efficiency, reduce latency, thus increasing speed of the transaction, increase profit, increase security, decrease cost, increase reward incentive, and invoke a surcharge predetermined by the consumer.

Referring now to FIG. 6B depicting a screen shot of the third-party Web page of FIG. 6A highlighting a secure transfer of data from a first data platform (14) (first database) to the end device browser application of the consumer. An act performed by the consumer with pop-up window 51 open, referred to herein as act 112 invokes a discount network 59 from within the pop-up window 51, such that clicking on the discount network 59 icon invokes coupon-codes which are auto-filled into the checkout boxes of the Web page 53 to reduce the cost of the consumer's selected product or service. In this instance, the first data platform 14 may connect by way of network (18) to a third-party platform (28) that is adapted to provide a service for aggregating electronic coupon codes. In an act 113, an auto-fill function is invoked to auto fill one or more checkout data entry boxes on the Web page 53. This may be accomplished without requiring an application program interface (API) to the third-party Web page in the consumer's browser, or a form navigation re-direct away from Web page 53.

Referring now to FIG. 6C depicting a different third-party Web page adapted to practice the present invention. This screen shot highlights a secure data transfer of data from the end device or appliance of a connected consumer to the first data platform (first database). A consumer may invoke discount network icon 59 in pop-up window 51. This action enables the consumer to simply hover with mouse or other selection device to hover over any data presented on web page 53 to automatically invoke and display images and other information about a product or service offered at competitive or discounted pricing from other Web sites through meta browser window 51. In this way, a consumer may easily ascertain whether they are getting the best value for the same product prior to committing to a purchase.

It may be noted herein that a web browser extension or a web meta browser includes a computing program from the first data platform (14) that extends the functionality of a web browser in some distinct way. Depending on the browser and the version, the term may be distinct from similar terms such as plugin or add-on. Some extensions are authored using web technologies such as HTML, JavaScript, and CSS.

Browser extensions can change the user interface without directly affecting viewable content of a web page. For example, a “widget” is a click-able graphical user interface object that may be added. One with skill in the art will appreciate that each browser type has its own architecture and APIs to build an extension which may require different code and defined tasks for each extension. Development frameworks such as Extension Maker , or Crossrider may be used to build cross-browser extensions with only one code base and one API. This limits or obfuscates the need to develop a different extension version for each of the popular browsers like Internet Explorer, Firefox, Chrome, Safari, and Opera.

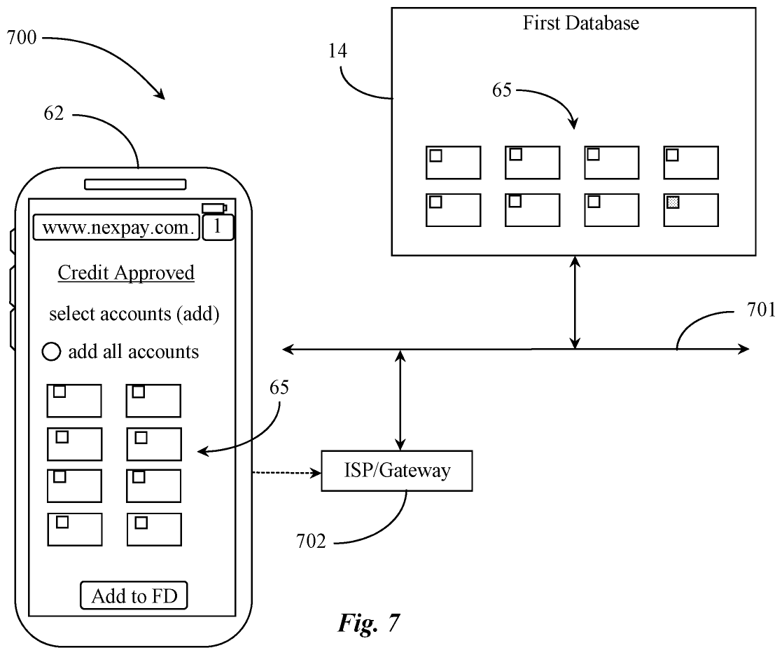

Referring now to FIG. 7, an architectural diagram 700 depicting auto population of financial accounts into the first data platform (database) of FIG. 2 from a consumer device 62. In this view a consumer operating cell phone device 62 with a thin client application 65 may populate the first data platform 14 with one or more financial accounts 65. In a preferred embodiment, this is authorized by credit approval. The consumer may use device 62 and may select and upload accounts through ISP gateway 702, network backbone 701 and into the first database 14.

A screen shot depicts device 62 and a credit-approval notification setting the consumer up for adding financial-related data. A selection option for choosing accounts 65 to add to platform 14 is included as well as an option to fully load all of the financial accounts. Another option at the bottom of the screen shot allows submission to the database of the selected accounts. In process, an electronic credit report of a consumer may be accessed and vetted, then the approved accounts may appear in the screen shot for add. The first database may electronically extract payment-related data from a displayed graphic or picture representing an account added.

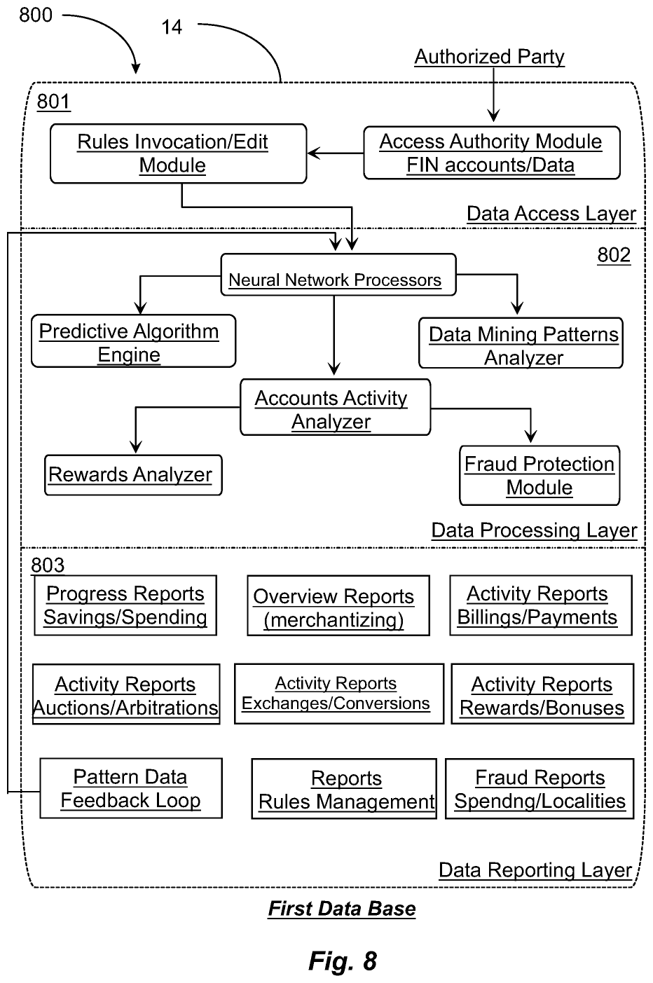

Referring now to FIG. 8, a block diagram 800 depicts general processing, analytical components, and process categories in the first database SW. Diagram 800 depicts layers of SW functionality segregated into a data access layer 801, a data processing layer 802, and a data reporting layer 803. A consumer's financial account data may be accomplished through the user account registry (UAR) 15 previously described. Access functions may include but are not limited to querying, editing, and transacting with the financial relative data (67).

In one embodiment, an authorized party, user, or consumer, may gain access to financial data through an access authority module wherein a query may be accompanied by invoking a rules module (50) that may result in among other things, a presentation of advertisements or rewards incentives to the consumer while the consumer is querying their financial accounts (65). Invocation of any rule through the rule module 50 in data access layer 801 may trigger neural network processor functions in processing layer 802. Various processors may launch pan-portfolio analysis, wherein a consumer may access their user account registry and invoke rules by performing a key-word search. Returns may include processed data such as reports including report on any activity in their financial accounts, report on spending by category of expenditures, a report on the chronology of expenditures, a report on items that may be tax deductible expenditures, etc.

Processing layer 802 may include dedicated processors for predictive analysis (predictive algorithm engine), data mining (patterns analyzer), activity detection (accounts activity analyzer), rewards calculation (rewards analyzer) and fraud protection (fraud protection module). Data reporting layer 803 may include results of the various processes occurring in the data process layer 802 including but not limited to progress reports on savings and spending, overview reports (merchandising), activity reports on billings and savings, activity reports (auctions and arbitration), activity reports (exchanges and conversions), activity reports (rewards and bonuses), reports on rules management, fraud reports (spending), and a feedback mechanism for feeding back pattern data to help refine the processing layer functions.

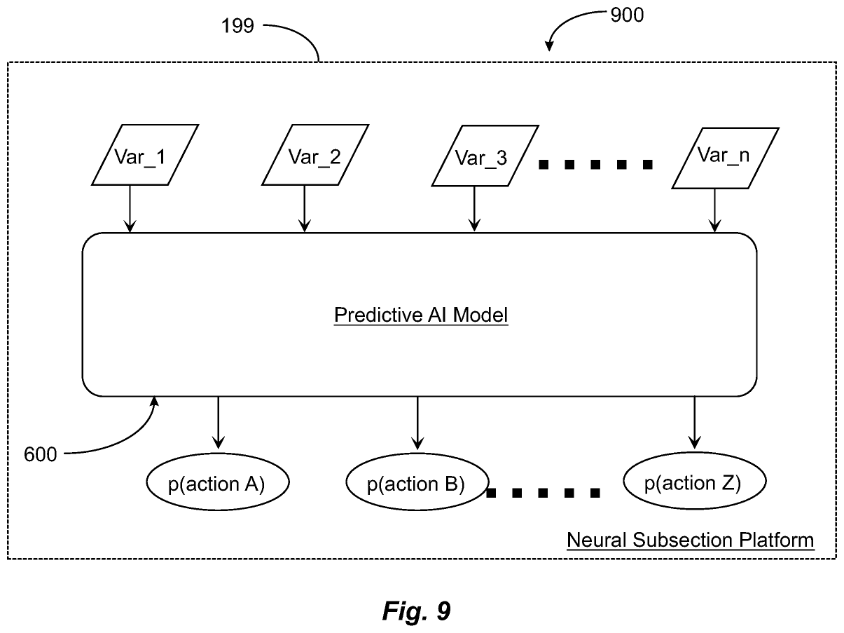

Referring now to FIG. 9, a block diagram 900 depicts processing on a neural subsection platform. In one embodiment, a neural network processing platform 199 is provided. A predictive AI model 600 is provided that may be a rules based trained model 600 and neural platform 199 may be provided within the first data platform which include rules governing predictive fraud, predictive purchasing patterns, predictive rewards redemption, predictive risk-management tools, predictive account preferences, predictive impact on the consumer resulting from advertisements, and the like.

Predictive Model 600 includes a set of input variables VAR (1-n) representing a set of n potential single actions for processing. Model 600 may use predictive algorithms supported by rules in a rules base to produce probability statistics as output of a given action (actions A-Z). Output is expressed as p(action A) through p(action Z) where the statistics point to the potential or probability for actions to occur with specific accounts. In one implementation, actions A-Z represent actions where exhaustive enumeration may occur during processing, for example partitioning of numerous complex actions.

In one embodiment, a constraint optimization may be performed in calculation to normalize statistical probabilities (sum up to 1). However, normalization may be avoided in one embodiment by constructing individual predictive models to estimate the marginal probability for each individual complex action predicted. An implicit segmentation may be imposed by setting a low threshold for each marginal probability. For example, let R be a segment of the population for which P(action A) is less than a specified threshold (TsubA). The desired segmentation might be obtained through scoring the pan-portfolio data (all of the accounts in the UAR). The probability given a complex action may be computed either by using the predictive model estimate, or by using a prior probability statistic associated with an action. The prior probability for a population segment may be calculated as the probability to pay, given all possible actions, whose marginal probabilities exceed the corresponding thresholds TsubI, TsubJ TsubK and so on. As more and more data are gathered about the actions, the prior probability statistic may be modified to reflect the latest statistic citing probable success or failure of the action in benefiting the consumer.

In one embodiment, neural platform 199 includes a tracking agent that is able to take data from the consumer's existing ad preferences and online activity patterns to periodically recommend to the consumer new information that may lead to a bolstering or to a reduction of the consumers broad pattern data and to a modification, addition of, or deletion of current execution commands based upon algorithmic projection of what the consumer's online preferences and activities may look like in the short term or longer term future.

In a preferred implementation, neural platform 199 learns from a training process that may include (1) Repeatedly inputting samples of a particular input or output task to a neural network model, (2) Repeatedly comparing the actual data output from the model to the desired output of the model and quantifying error, and (3) Modifying model weighting constants where exposed to reduce error. The steps are repeated until further iteration fails to decrease the error values. Once training is completed, neural platform 199 may better predict outcomes for new data inputs. Known programs or software systems adapted to run platforms like platform 199 may include Neural Designer™, Neuroph™, Keras™, Tflearn™, and NVIDIA DIGITS™.

In another embodiment, an execution command 52 may be adapted to trigger an intelligent tracking agent to acquire and process data acquired about the consumer's Internet browsing to provide personalized recommendations to the consumer relative to new products and services available from any number of Internet Web sites or Internet money or value account issuing sites. An execution command example might be a command to track and record new types of music, books, and investment opportunities discovered and that reflect the preferences. Recommendations may be preselected based upon the aggregation of and comparison of prices from various third-party platforms.

In another embodiment, an execution command 52 may be adapted to trigger a data tracking agent or screen scraping application to track and record data in a consumer's calendar or schedule and then after analysis, to provide the consumer with customized recommendations on offerings for products, services, or upcoming events based on the.

Other execution commands cover presenting and displaying information to the consumer based on real time scheduling and activities including location. A consumer may see consumer rewards incentives, customized advertising. For example, the consumer may see an ad for ski apparel when the consumer's schedule indicates a ski trip departure, location arrival, or in time reserved before the trip is scheduled. A consumer might see an advertisement for new coffee flavors from the consumer's preferred vendor during the consumer's morning work session. An execution command may be created for displaying information relative to a consumer activity program the consumer connects to using an Internet capable device like a fitness tracking device or an exercise machine or station where presented data may include prior statistics and recommended time and task performance steps or repetitions to enhance or improve the consumer's progress toward a longer-term goal. There are many possible use case scenarios.

As described further above in this specification, an execution command 52 executes a routine or series of events including transactions based on one or more rules from a rules base described as rules module 50 containing rules associated with execution commands. In another embodiment, an execution command may cause an account issuer to contribute money or value to a different account issuer based upon a consumer's purchases. In such transactions, units of currency or value are electronically debited from the consumer account maintained at the first issuer and electronically credited to a designated consumer account maintained by the second issuer. An example might be a consumer purchase with Citibank™ Visa™ invokes a Rule that Citibank™ contributes 1% of the consumer's purchase amount to the American Lung Association™ registered third party account. Alternatively, Citibank™ credits 1% to the consumer's purchase amount from towards frequent flier miles in the consumer's Star Alliance™ rewards account. In the first instance, the transfer is from a consumer account to a third-party account that is not the consumer's account (pay). The second instance is a transfer from a consumer account to another consumer account.

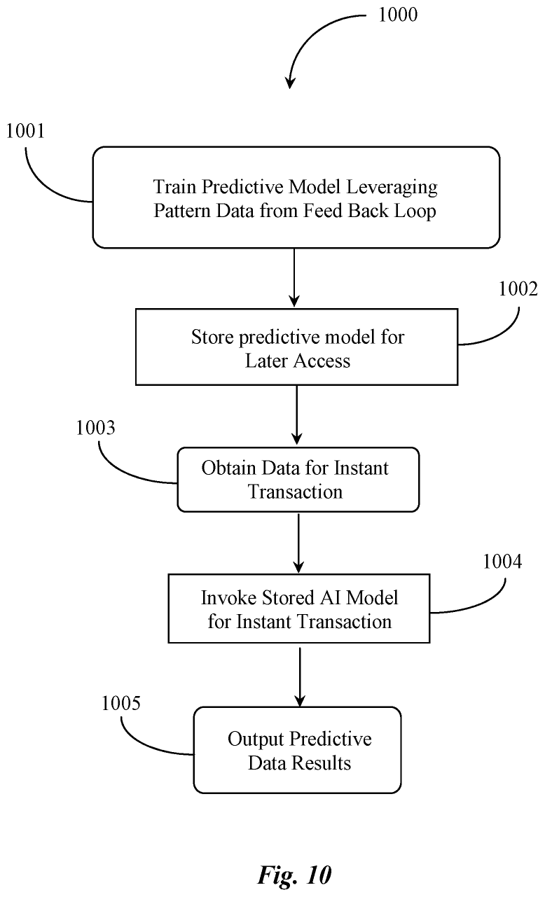

Referring now to FIG. 10, a process flow chart 1000 depicts steps for training the predictive model 600 of FIG. 9. At step 1001, the predictive model is trained using pattern data and new input variables. Training under step 1001 may include (1) Repeatedly inputting samples of a particular input or output task to a neural network model, (2) repeatedly comparing the actual data output from the model to the desired output of the model and quantifying error, and (3) modifying model weighting constants where exposed to reduce error as referenced above in FIG. 9 referencing predictive model 600.

At step 1002, the predictive model maybe stored in data platform 14 for later access during transaction events or activities that rely on the model to make decisions for and send recommendations to a consumer. At step 1003, the first data platform may obtain data relative to an instant transaction in process. An execution command invokes the predictive model during the transaction process offline (POS) or online (Checkout) transaction activity of the consumer.

At step 1004, the predictive model may be invoked and executed for the transaction in progress. At step 1005, the predictive model outputs predictive results relative to the current activity including options available to the consumer. In one embodiment, the predictive model may be used to make recommendations which may pop up as notifications in the meta browser window (51) of the consumer. In one embodiment, the predictive model output data may, according to one or more rules in a rules base (50), trigger an execution command (52) to perform a selection, invoke a program, highlight a specific account as a priority account, invoke an account, auto fill dialog boxes or the like.

The predictive model is not required in order to practice the present invention, however it functions to improve and fine tune the consumer's experience and helps to predict, in a general sense, the needs of the consumer moving forward and aids in some instances in advising the consumer or working on behalf of the consumer to accelerate achievement of a financial goal set by the consumer.

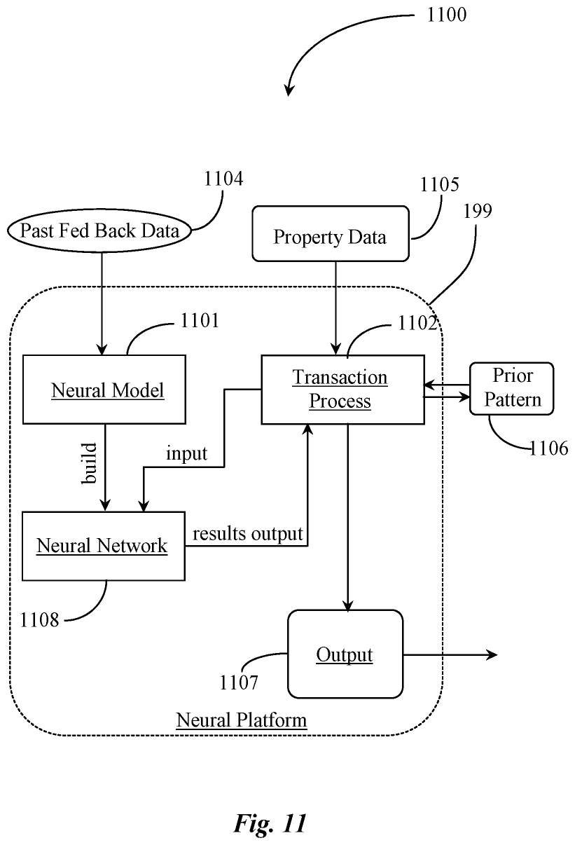

Referring now to FIG. 11, a block diagram 1100 depicts intelligent processing of instant transactions using the AI model 600 of FIG. 9. FIG. 9 illustrates overall functional architecture of the neural platform (NP) 199 of the data platform (first database) 14. Neural platform 199 is broken down into components including a neural model 1101, a neural network 1108, and transaction processing platform 1102.

Neural model 1101 uses past data 1104 to build neural network 1108 containing information representing learned relationships among a number of variables. Together, the learned relationships form a model of the behavior of the variables. Although a neural network is used in the preferred embodiment, any type of predictive modeling technique may be used without departing from the spirit and scope of the invention.

In this implementation, transaction processing platform 1102 performs three functions. A first function may be to make a prediction of probability of fraud for each transaction made. Data may be fed into the neural network 1108 by feeding input data from various sources. Property data 1105 may be fed into the transaction process 1102 and into the neural network 1108 according to the direction of the arrows.

Prior pattern data 1106 may be fed into transaction process 1102 and into the neural network 1108. Neural network 1108 may process data using rules and may output data results into the transaction process 1102 in near real time resulting in output data 1107 from the transaction process 1102. In one embodiment, transaction process 1102 may create records and output those back into a data base or store containing the prior pattern history of transactions that summarize the past transactional patterns of the consumer. Regular updating occurs with each transaction completed.

Neural model 1101 may further comprise software (SW) adapted to form learning tasks through repetitive exposure to data such as past data 1104 and adjustment of internal weights that may be provided as constants in rules-based equations. The system promotes rapid model development and automated data analysis. Moreover, neural networks provide at least one statistical modeling technique that is capable of building models from data containing both linear and non-linear relationships.

While similar in concept to regression analysis, neural networks are able to capture non-linearity and interactions among independent variables without prior specification. More particularly, while traditional regression analysis requires that non-linear metrics and interactions be detected and specified manually, neural platform 199 performs these tasks automatically. For a more detailed description of neural networks, see D. E. Rumelhart et al, “Learning Representations by Back-Propagating Errors”, Nature v. 323, pp. 533-36 (1986), and R. Hecht-Nielsen, “Theory of the Backpropagation Neural Network”, in Neural Networks for Perception, pp. 65-93 (1992), the teachings of which are incorporated herein by reference.

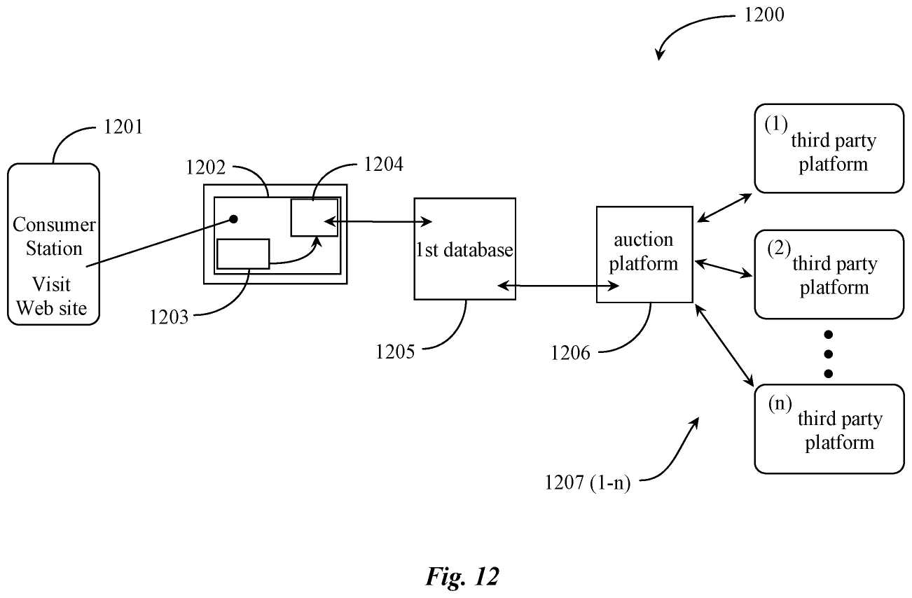

Referring now to FIG. 12, an architectural view 1200 of the network interaction between a consumer and competing third party platforms is depicted. In this embodiment, a consumer operating from a consumer station 1201 using a computing appliance connects to the network and visits a Website 1202 having an E Coupon field 1203. An electronic coupon (e-coupon) bidding transaction begins with the user visiting, the merchant Website 53 hosting the e coupon field.

A meta browser extension 1204 is invoked by the consumer to connect with a first database 1205. In this process, the meta browser extension may look for and store the consumer's cookies to help determine the consumer's Web browsing and buying history, including the consumer's interests, demographics, and the like. This data is transmitted over the network to the first database 1205. This helps determine which e-coupons may be most relevant to the consumer, and some of these may be presented to the user on the consumer's display device within the pop-up window afforded by the meta browser extension.

Once the consumer clicks on or hovers over a product or service, this may trigger a bid request invoked and communicated by the meta browser extension 1204 from the 1^{st} database 1205. The bid request may include various pieces of data such as the product name, vendor, features, and product retail price. The bid request enables third party platforms 1207(1-n) to assign a value to their e-coupon with specificity for an auction held between the TP platforms.

The bidding request is communicated from the 1^{st} database 1205 to an auction platform 1206. The auction platform 1206 submits the bid request and any accompanying data to a plurality of third-party platforms 1207(1-n). Each notified platform may automatically submit e coupon bids in real-time to auction platform 1206. The objective is to win at auction and be allowed to place their e-coupons and or e-coupon codes in e-coupon code entry field or form 1203 on the merchant's website 1202.

The e-coupon providers bid on each product or service being clicked on or hovered over by the consumer as it is entered into to the first database by the Web browser extension or meta browser extension 1204. The c-coupon placement right goes to the highest bidder, for example, the provider of the largest discount on the advertised product or service. The winning e coupon or e coupon code is served to the first database and forwarded by proxy to the e coupon form or field 1203 on the Web page 1202. The discount is calculated at the Web page resulting in a new price of the product at check out.

In a preferred embodiment, the bidding happens automatically between digital auction services and the third-party e coupon providers. Statistical probability models can be used to determine the probability for a conversion by the consumer, defined as the consumer accepting the c-coupon code to apply the purchase given the consumer history data based upon the consumer's browsing and buying, patterns stored in the first database (first data platform). This probability value may, in one embodiment, help providers to determine the amounts of their bids for competing to fill the e-coupon placement field on the Web page order.

### Selected Third Party Transacting

Referring now to FIG. 7, the present invention utilizes a transaction network including a first database 14 on a first server a consumer is registered with and is authenticated by whenever the consumer or another third party accesses the server. In part the service maintains financial accounts 65 of the consumer that the consumer registers into a consumer account registry or user account registry (UAR). In FIG. 7, a consumer or user is uploading accounts to the registry after being authenticated and credit approved. The consumer may be issued a unique user code (UUC). A UAR may be identified by a UUC or a user account registry code combined with a personal verification code (PVC) at the shopping cart level of online transacting.

In a typical embodiment, if an account issuer approves a transaction, the automated process returns a transaction number to the consumer's user account registry. The consumer's financial account 65 is adjusted through either a credit or debit action. The transaction number and transaction history are recorded and available to the consumer in a report. The consumer need take no further action since financial transactions are automatically settled.

Parties, being the consumer and third parties that wish to either originate or receive financial transactions first register with the First Database 14, and its associated verification platform and account registry platform. The verification and financial information registered with the first database or authorized third party equivalent for a given party depends on the mode used to originate or receive settlement. A user or consumer may be an individual person or a corporate entity and should have a unique user code and optionally, a personal verification code and access to a rules base and execution commands for governing actions like access, deposit, display, deduct, and disburse relative to at least one financial account.

It is noted herein that a UUC may be a unique digitized data string which is assigned to or selected by a user or consumer. It might be a digital certificate, an electronic “cookie”, a network credential, an Internet protocol address, a digital signature, a token string, an encryption key, and may include a biometric rendering. The PVC may be any code which the user can enter in an authentication session like an alphanumeric or symbolic code. The UUC and optionally the PVC are submitted to a verification platform to identify the consumer or user and authorize the consumer to access the UAR.

It may be noted herein that the term user and consumer may be synonymous and that the term consumer may be used exclusively or interchangeably with the broader term user. In one embodiment, a consumer may be issued an executable token which may be stored on the consumer's computing appliance wherein the token includes a meta browser extension that provides a secure transaction interface with third party entities wherein the personal identification code (UUC/PVC) are included into the token. In this embodiment a user may execute the token like an application from its shortcut on the consumer's computing appliance. The token producing the meta browser may also be executed remotely or triggered based on certain online actions by the consumer as governed by a rule or rules and one or more execution commands, like visiting a third-party web page and navigating to a secure checkout page (shopping cart level) by placing an item in a shopping cart. In one embodiment the unique user code stored on the executable token may be one of a software cookie, a telephone number, an email address, a subscriber identification module card number, an internet protocol address, a customer computing token hardware identification number, a data string generated by a server or a combination of any of those.

In one embodiment, the generated executable token stores the meta browser extension and specific input commands that may override normal input commands like a computer mouse or mouse pad input. For example, allowing a consumer to hover over an interactive image, an interactive icon, or an interactive text block displayed in the meta browser pop up window to see additional meta data or to initiate a navigation within the meta browser itself independent of the host browser application obfuscating click on or click through functions. For touch screen capability, the specific integration may be to enable the consumer to hover with their finger over the image, icon, or text without requiring thew consumer to tap on or tap through the image, icon, or text.

In one embodiment, the executable token includes the meta browser program and stores data relative to the consumer's activity patterns and preferences aggregated from multiple transactions and other online activities conducted by the consumer using the meta browser or the host browser. In this embodiment, the account registry platform may periodically tap the consumer's token for data to employ in a process of searching for and aggregating advertisements, offers, or other values that are of interest to the consumer based on the token data.

In one embodiment, a consumer token may be equated to or represented by a personal computing appliance that may be referred to as a consumer's token computing appliance, or the appliance that is authorized and registered with the service and that can be automatically identified and verified as authentic at the first connection with the authorizing server associated with the first database and the consumer's UAR. In this embodiment then, the token may refer to the consumer's smart phone, a smart card, tablet computer, or other personal computer. The concept of consumer token may therefore be as specific as token software stored on the consumer's appliance or as broad as the consumer's appliance without departing from the spirit and scope of the invention. However, in the more specific embodiment of a SW token, the token and token data may be encrypted and decrypted by the remote server.

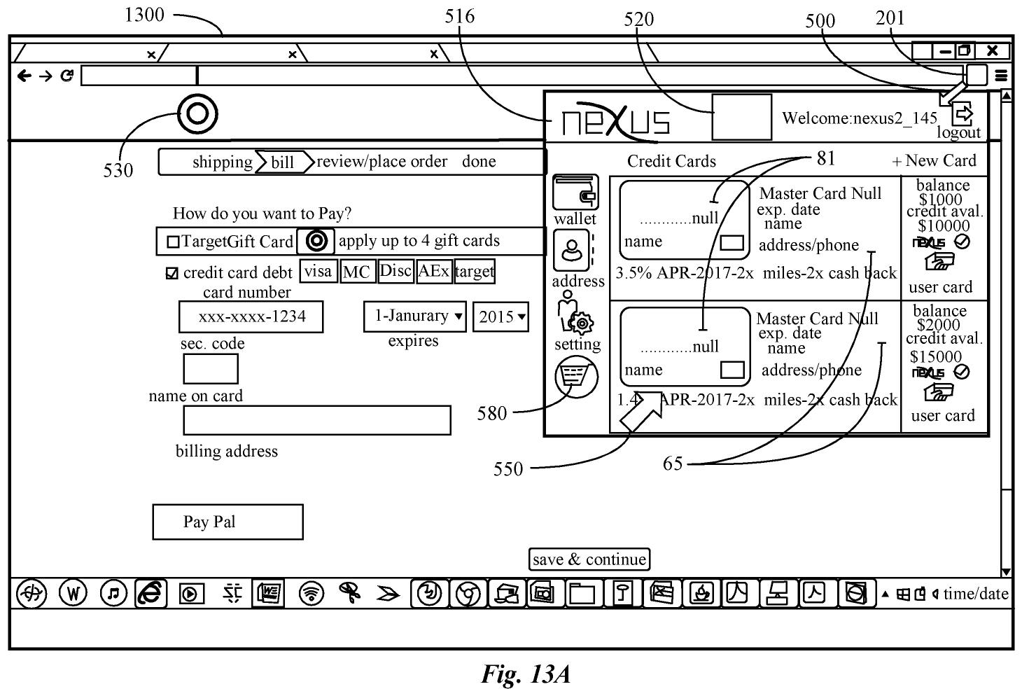

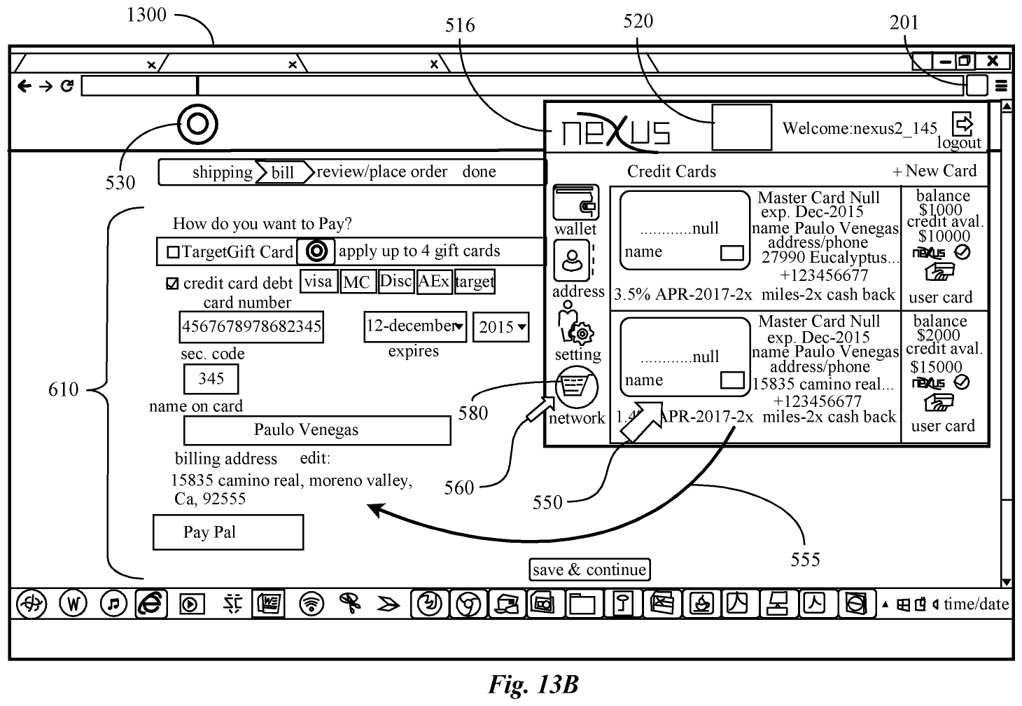

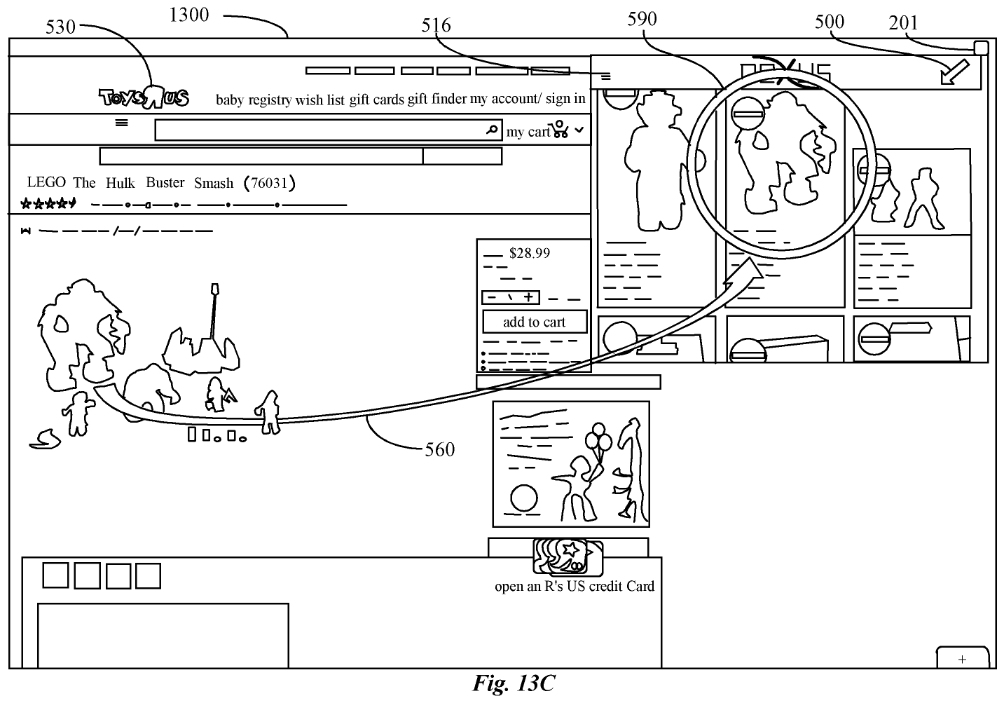

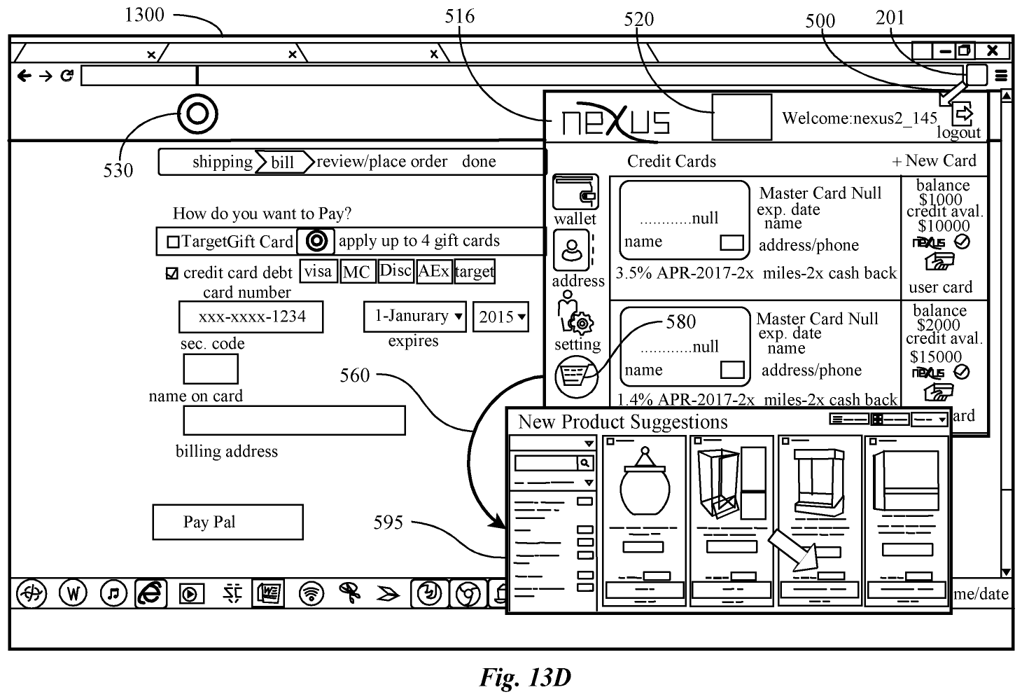

Referring now to FIG. 13A, a consumer appliance display 1300 depicts a third-party Web page 530 that is displayed as a result of consumer navigation to the page leveraging a browser application executed on the consumer's appliance connected to the network. In this embodiment, the consumer is in the process of transacting and third-party Web page 530 is a secured transaction page navigated to by the consumer selecting a product for the shopping cart and check out. The consumer has reached page 530 by placing an item or service request into a shopping cart on Web page 530. In one embodiment, meta browser pop up window 516 is triggered by a rule (50) and an associated execution command (52) to display as a result of the item or service requests triggering the transaction sequence at check out (secure transaction).

Pop up window 516 includes signature cards 81 defining the data for financial accounts 65 and displayed as suggested financial accounts for use in the current transaction. The consumer may select a preferred account as depicted by directional arrow 550 pointing to the account having the larger available balance and lower interest rate. In one embodiment, pop up window 516 is executed by the consumer from an icon 201 located for example, at the top corner of the native browser panel as depicted herein by touch screen or mouse input as depicted herein by directional arrow 201.

Therefore, pop up window 516 provides access to payment settlement as directed or approved by the consumer without the consumer being required to type anything into data entry fields or authenticate to the server. Pop up window may, in one embodiment execute from a token on the consumer's appliance or, in another embodiment a SW application stored on the consumer appliance. Interactive features wallet, addresses, and settings appear above the shopping cart icon that is in the pop-up window in a left side navigation panel. Pop up window 516 may at any given time display dynamic and interactive advertisements or value offers like an interactive coupon, or advertisement 520. These displayed advertisements or notifications (in one embodiment) may be aggregated from one or more third party provider platforms based on token data revealing the consumer's current or latest product or service preferences or needs. In this and other ways, pop up window 516 is customized to the consumer and only reveals consumer pattern data to the consumer unless performing an authorized transaction.

It is noted herein that the executable 201 invokes pop up window 516 without requiring any form re-direct away from third party Web page 530 and without requiring application program integration (API) with the third-party page 530. In one embodiment, a trainable software (SW) agent 580 is provided in the form of a shopping cart in pop up window 516 that is adapted to receive “add to cart” data such as a consumer selected or otherwise highlighted product dropped into a shopping cart on the third party secure order page like page 530 and use it to launch a search algorithm to look through third party advertisement data from multiple third party providers for similar products and available pricing, discount offers, and shipping availability information and aggregate that data for presentation to the consumer through pop-up window 516. The extrapolating SW agent may be invoked by automated trigger or by the consumer by selecting or hovering over the shopping cart icon 580 or step 560 (directional arrow).

Referring now to FIG. 13B, the consumer appliance display 1300 of FIG. 13A displays the third-party Web page 530 of FIG. 13A being auto populated with pattern data from the meta browser pop up window 516. In this embodiment the consumer is transacting with the merchant advertising on Web page 530. The consumer has selected a preferred account 65 and card 81 from suggested accounts and signature cards presented in pop up window 516 as evidenced by step 550 (directional arrow).

In this embodiment, one task among other tasks that may be performed by the meta browser extension pop up window 516 is to automatically populate data entry fields of a checkout form 610 with the payment-related data belonging to the consumer's selected financial account selected at step 555 (directional arrow). The meta browser may auto populate any secure web form through the consumer's host browser displaying the secure check out form, in this case Web page 530. In one embodiment, a consumer may select a value offer through the pop-up window 516 that is not available through the secure page currently displayed in the consumer's host browser. In such an event, the meta browser extension navigates to the new secure checkout page of the offering party and displays that in window 516 or feeds the URL to the host browser for display over Web page 530.

In this embodiment, a hover-over input function enabled within window space 516 allows the consumer to hover over an advertisement or other interactive content displayed to invoke more meta data associated with the interactive icon or text to display while the hover-over function is being executed by mouse or touch (touch screen, mouse pad). It may be noted herein that meta browser pop up window 516 may, in one embodiment, be expanded to full screen, or minimized to the desktop and so on like other open windows on the consumer computing appliance.

Referring now to FIG. 13C, consumer appliance display depicted a different third-party Web page advertising a product or service. In this embodiment, a consumer may invoke pop up window 516 while browsing products or services at any third-party Web page. The consumer may simply click on executable icon 201 at step 500 (directional arrow) to invoke the pop-up window. The intelligent software agent 580 that performs comparison searches against products placed in a shopping cart by the consumer is operable in a slightly different mode in this embodiment.

In this example, SW 580 may use information (pattern data) from browsing history including current navigation. For example, meta browser 516 may track the consumer's Internet browsing activity. When the consumer highlights or selects a product, pop-up window 516 may collect that available pattern data and automatically conduct an online data search among available third-party providers at step 560 (directional arrow). The search may use the fresh pattern data reflecting the consumer's current browser selection and associated data.

Data returned to display within pop up window 516 may include value offers aggregated from the polled third-party sites that are at least similar to or in the same category as the product highlighted or selected to view by the consumer browsing the product section of a Web page. The data returned may be prioritized by how close the value is to the actual product being looked at by the consumer, for example, product 590 offered through pop up 516 is the exact same product that the consumer is interacting with in the main browser frame. Such comparison searches return data that reflects consumer-oriented Web browsing practices and preferences.

Competing third parties may be registered members of the service without departing from the spirit and scope of the present invention. In a preferred embodiment, all third parties that may transact with the consumer through pop-up meta browser window 516 are at least verified as trusted sources through the verification platform of the first database. Competing merchants may include reward incentives providers, banks, internet payment providers, barter providers, insurance companies, credit account organizations, brokerage firms, retail sites, and so on.

In a preferred embodiment, a consumer may calibrate the extrapolating SW agent for performance by constructing or selecting or constructing a rule and associating an execution command (data aggregation and return for display)) according to one or more criteria. For example, search for third party sites offering a same or similar product at value comparative or better pricing whenever I place a product into a shopping cart. Another configuration might be search for third party sites offering same or similar products based on the last five product selections in my browser history. Another may be search for third party sites offering only the exact product or service I am currently selecting or highlighting for review. There are many possible variant configurations that may be made to automatically trigger a search when the pop-up window is open. Furthermore, the consumer may execute the intelligent agent to perform a search on the fly.

In one embodiment, the SW agent may query an Internet-accessible calendaring program of the consumer for data about products, services, and or activities of interest to the consumer as evidenced by calendar entries. The agent 580 may discover and extrapolate data from the consumer's existing browsing preferences, existing buying patterns, and perform a search and return meta data to the consumer that includes product and service description, pricing, discounts, and other perks. This pattern activity is also recorded and fed back to a neural network in some embodiments lending to predictive or predictable consumer patterns likely to reflect interests of the consumer for use in predictive algorithms that may cause comparison searches of third-party providers based upon the intelligence developed during the course of the consumer's many tracked activities.

In one embodiment, pop up window 516 may be configured to send emails, notifications, text messages, voice mails, content invitations, and calendar suggestions to a consumer that seek to inform the consumer of the current or future availability of value offers for products or services available through one or more third party providers assessed as important or preferred by the consumer. Agent 580 is an executable routine associated with one or more rules and available pattern data from the consumer as verified by the consumer's unique code and as aggregated by a tracking module that may be configured by the consumer. The rule may be associated with pattern data comprising a unique customer code and meta-data about products and services of interest to the customer, said meta-data having been uploaded from an Internet-connected customer computing token (SW, computing appliance, wearable device, smart card, etc.) and the execution command launching the agent to perform the data search and aggregation.

Referring now to FIG. 13D, consumer computing display 1300 depicts aggregated results of a comparison data search displayed in a second interactive pop-up window executed by the meta browser. In this embodiment, the consumer is in the secure transaction mode on Web page 530 and pop-up window is executed from icon 201 during step 500 whereby the icon is clicked by a consumer, or it is executed automatically when the consumer placed a product into a shopping cart at an online Web page to bring up a secure transaction page like Web page 530.

A second pop up meta browser window 595 may be spawned from the first window 516 after a comparison search is executed and results are available. In one embodiment, value offers included in the results are displayed in window 595 as a result of step 560 that may be triggered by a product review underway by the consumer, by a historical pattern of transacting, by placing a product into a shopping cart, or by a historical pattern of browsing, or by a combination of those pattern data.

In this embodiment pop up window 595 includes compartmentalized interactive advertisements that each include product imagery, product description, product pricing, links to purchase, links to see more information, ad in one instance a link to product reviews by past customers. Each compartmentalized advertisement is associated with meta data that may be viewed by a consumer using a hover-over function of the mouse or touch screen gesture. In this embodiment, each compartmentalized advertisement is selectable by the consumer to use as criteria for a more refined value data search limited to the narrower features of each different product advertised. Window 595 also includes a manual search panel (left) including a refinement function. Content within window 595 may be arranged in list view, grid view, as small or large icons, and so on.

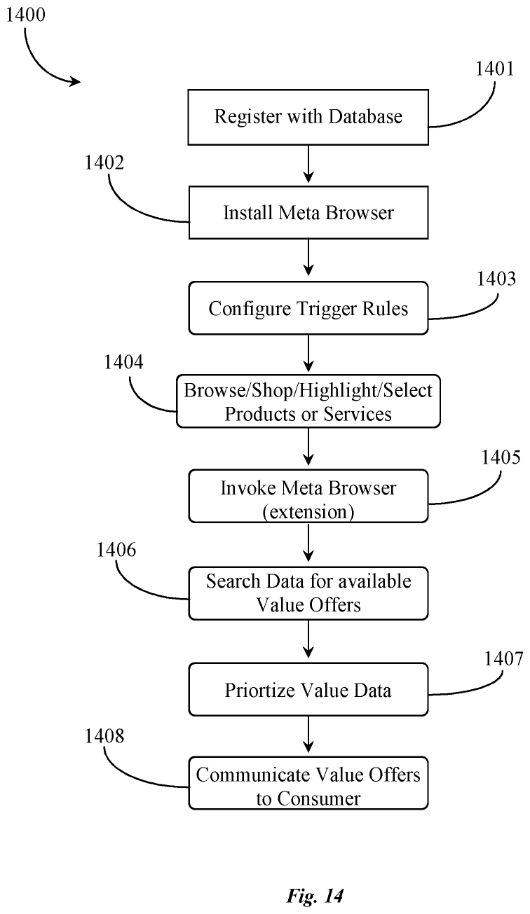

Referring now to FIG. 14, flow chart 1400 depicts steps for enabling and invoking the intelligent SW agent of FIG. 13D according to one aspect of the invention. At step 1401, a consumer registers with the first database server including registering one or more financial accounts with the server in a user account database. The registration may include a unique user account code, optionally combined with a personal verification code to authenticate the consumer upon connection to the platform.

At step 1402, the consumer may download a meta browser extension or meta browser that nests itself into the consumer's main browser application. The meta browser extension may automatically install and may reside on the consumer's personal computing appliance nested in a main browser application and be associated with the consumer's unique user access code for authenticating with the first database server. At step 1403, the consumer may execute the meta browser to access the first database and configure one or more rules for governing specific aspects of transacting between the user account registry and third-party platforms on behalf of the consumer. The one or more configured rules may be associated to specific consumer accounts ad may include pattern data and one or more execution commands that may be triggered by matching actual activity data to the rule pattern data model.

The meta browser may collect browsing history, navigation path history and other data from the consumer's activities online and offline with permission granted by the consumer using the meta browser. Once the meta browser is installed and the consumer is registered with the first database server, the consumer may as normally practice shop online visiting third-party provider sites browsing products and services offered at step 1404. At step 1405, the meta browser or meta browser extension may be invoked manually by the consumer or may be invoked automatically through a configured rule and one or more execution commands.

The meta browser may execute at step 1405, for example, as a result of a current activity executed by the consumer that produces pattern data that matches pattern data in the rule executed. In one embodiment, placing a product in a shopping cart and going to a secure checkout page automatically executes the meta browser to spawn a pop-up window in the consumer's main browser frame. It is noted herein that the meta browser extension may be running in the background on the consumer's personal computing appliance monitoring consumer state and activity without the execution of the pop-up window in the consumer's main browser frame. It is also noted herein that some monitoring tasks may enable the meta browser to operate without the main browser it is nested in. For example, the meta browser may wake up and monitor consumer activity while the consumer is working in a calendar program offline.

At step 1406, the meta browser has been executed and may produce a pop up interactive browser window representing the consumer's pattern data (financial accounts), and may according to recent activity by the consumer, launch a search for products or services of interest to the consumer including product or service descriptions, hidden meta data that may be accessed by hover-over input techniques executed by the consumer, embedded universal resource locators (URLs to third-party information or checkout resources, and so on. In one aspect in step 1406, the meta browser is triggered to conduct a search of available value offers based on activity that the consumer has navigated to a check out page for initiation of a secure transaction. In this case the value offers will match consumer pattern data such as the product or service description of the product or service selected by the consumer.

At step 1407, the intelligent software agent aggregating the value data may prioritize the value data according to one or more rules set by the consumer. For example, the consumer may wish to see the exact product only but not similar products. The consumer may want to see the least expensive value offers first in a list of value offers. A search for value offers may be a broad search or a narrow search depending on the activity and the consumer's goals. For example, a consumer may be planning to purchase a product from one third party provider but may want to see accessories that go with the product from a variety of other third-party providers.

At step 1408, the value data reserved for return to the consumer may be communicated to the consumer in interactive compartmental advertisements enabling the user to see and interact with the advertisements within the pop-up window spawned by the meta browser, or within a second pop up window spawned in addition to main pop-up frame enabling the consumer to work within both windows floating over the consumer's main browser frame. In one aspect, the value offers may be sent to the consumer in traditional forms of communications like emails, phone texts, or notifications to any of the consumer's social media platforms where the third party has a presence. In a preferred embodiment, consumer may hover over the value offers to see and read additional meta data descriptions and or to see visible network links for redeeming offers or purchasing the products using a selected financial account.

The meta browser pop up window may offer a variety of other tasks as well like auto population of consumer financial information and other pattern data into online order forms or entry fields including fields for financial information and passwords (auto log-in), and fields for personal information about the consumer that the consumer has enabled the meta browser to track like consumer dimensions for fitting clothing, shoes, hats, or other products routinely purchased by the consumer. A consumer may create pattern data expressing consumer preferences and may associate that data with rules and execution commands to cause the automated transacting and account settlement on behalf of the consumer where the consumer does not have to enter data by typing or voice dictation and wherein the consumer does not have to jump off of a Web page or be redirected to another Web page with respect to the main browser. More particularly, direct transactions may be performed with any third-party provider that is authenticated to work with the first data platform directly through the pop up meta browser window.

It will be apparent with skill in the art that the transaction control interface of the present invention may be provided using some or all the elements described herein. The arrangement of elements and functionality thereof relative to the smart card of the invention is described in different embodiments each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

What is claimed is:

1. A financial transaction network comprising:
a first server connected to the network, the first server coupled to at least one data repository containing financial account data belonging to individual ones of consumers identified by a unique code;
a second server connected to the network, the second server coupled to at least one data repository containing data supporting third-party value offers in the form of products and services;
a server interface to the first server distributed over the network to individual ones of computing appliances connected to the network as end nodes, the computing appliances operated by the consumers; and
a non-transitory medium resident on the first server, the non-transitory medium containing machine-readable code thereon, the code executable and instructing the first server to;
(a) register financial account data for the individual ones of consumers in a consumer account registry on the first server and create a unique token for each registered consumer for authentication at the first server;
(b) oversee consumer selection or creation one or more rules-based executable routines or commands and association of created rules to individual ones of consumer accounts;
(c) aggregate pattern data about the registered consumers and storing or caching that data for use as search criteria for locating value offers;
(d) host the execution of the server interface and upon execution thereof spawning an interactive meta browser window to display on the consumer's computing appliances;
(e) use some of or all of the consumer pattern data aggregated in (c) as criteria to match with third party value offers; and
(f) communicate one or more of the matched value offers to the consumer through the server interface.

2. The transaction network of claim 1, wherein the unique code includes a user account registry code and a personal verification code.

3. The transaction network of claim 1, wherein the financial account data may include a proxy financial account number associated with an actual financial account number residing on a third-party server.

4. The transaction network of claim 1, wherein in (a) the unique token comprises the domain of consumer's end node or the domain of a software component residing on the consumer's end node.

5. The transaction network of claim 1, wherein in (b) the one or more rules-based executable routines or commands are automatically triggered by one or more actions by the consumer, the one or more actions identified in the one or more rules.

6. The transaction network of claim 1, wherein in (c) the aggregated pattern data about the registered consumers is aggregated locally and uploaded to the first server by the consumer end node.

7. The transaction network of claim 1, wherein in (c) the aggregated pattern data about the registered consumers is aggregated at the first server.

8. The transaction network of claim 1, wherein in (d) the server interface is nested in one or more of the consumer's preferred resident browser applications.

9. The transaction network of claim 1, wherein in (d) the interactive meta browser window is executed manually by the consumer.

10. The transaction network of claim 1, wherein in (d) the meta browser window uses specific input capabilities to enable consumer hover-over of interactive content to execute display of hidden meta data associated with the content.

11. The transaction network of claim 1, wherein in (e) the criteria to match with value offers is configurable by the consumer to be narrowed or to be broadened.

12. The transaction network of claim 1, wherein in (f) the matched value offers are communicated as compartmental interactive advertisements including interactive graphics, interactive text, and at least one universal resource locator (URL) to a secure transaction Web page.

13. The transaction network of claim 1, wherein in (e) the value offers may be provided by or sponsored by on-line merchants including reward incentives providers, banks, internet payment providers, barter providers, insurance companies, credit account organizations, and brokerage firms.

14. The transaction network of claim 1, wherein in (a) the unique code further includes a software cookie, a telephone number, an email address, a subscriber identification card number, an internet protocol address, a customer computing token hardware identification number, or a data string generated by the remotely located server.

15. The transaction network of claim 12, wherein in the visible advertisement data or associated meta data includes one or a combination of product pricing data, product dimension data, product color data, product or service operation data, product or service feature description, product or service title or brand identification data, name of manufacturer or provider, product delivery or pick-up availability data or service start data, and location data for product pickup.

16. The transaction network of claim 1, wherein in (d) the server interface spawns one or more additional interactive pop-up windows communicating compartmental interactive advertisements representing the value offers matched to using consumer pattern data for products or services.

17. The transaction network of claim 1, wherein in (d) transactions may be initiated by the consumer selecting a preferred account displayed within the pop up meta browser window.

18. The transaction network of claim 1, wherein in (d) transactions may be initiated by the first database by proxy for the consumer, the first database functioning as an agent representing the consumer.

19. The transaction network of claim 11, wherein in (e) the criteria to match with value offers is specifically limited to data about accessories a consumer may add to a product the consumer has purchased, is in the process of purchasing, or will purchase.

20. The transaction network of claim 6, wherein in (c) the aggregated data is periodically retrieved from the consumer's appliance through the server interface on a periodic basis.
